(19) United States
(12) Patent Application Publication
(10) Pub. No.: US 2016/0180476 A1
(43) Pub. Date: Jun. 23, 2016

(54) SYSTEM AND METHOD FOR DISCOVERING RESTAURANTS, ORDERING FOOD AND RESERVING TABLES

(71) Applicant: Munch Ado, Inc., New York, NY (US)

(72) Inventor: Puneet Talwar, New York, NY (US)

(21) Appl. No.: 14/910,509

(22) PCT Filed: Aug. 7, 2014
(86) PCT No.: PCT/US2014/050247

§ 371 Date: Feb. 5, 2016

Related U.S. Application Data
(60) Provisional application No. 61/863,332, filed on Aug. 7, 2013.
(60) Provisional application No. 61/863,340, filed on Aug. 7, 2013.
(60) Provisional application No. 61/863,345, filed on Aug. 7, 2013.
(60) Provisional application No. 61/863,342, filed on Aug. 7, 2013.
(60) Provisional application No. 62/034,090, filed on Aug. 6, 2014.

(51) Int. Cl. G06Q 50/12; G06Q 10/02

(52) U.S. Cl. CPC G06Q 50/12; G06Q 10/02

(57) ABSTRACT

A method is disclosed for at least two of discovering restaurants, booking reservations and ordering food. A computing system may cause a remote computing device to display a first user interface that includes at least two of a first interface element via which a search for restaurants can be performed, a second interface element via which a search of available restaurant reservations can be performed, and a third interface element via which a search for restaurants from which food may be ordered remotely can be performed. The user specifies search criteria via a search interface for a selected one of the interface elements, and in response the computing system causes the remote computing device to display of a list of restaurants that satisfy the specified search criteria. The user may then book a reservation or place a food order with a selected one of the restaurants in the displayed list.

### CROSS-REFERENCE TO RELATED PATENT APPLICATIONS

This patent application claims priority to, and the benefit of, U.S. Patent Application Ser. No. 61/863,332, filed Aug. 7, 2013, U.S. Patent Application Ser. No. 61/863,340, filed Aug. 7, 2013, U.S. Patent Application Ser. No. 61/863,342, filed Aug. 7, 2013, U.S. Patent Application Ser. No. 61/863,345, filed Aug. 7, 2013 and U.S. Patent Application Ser. No. 62/034,090, filed Aug. 6, 2014, the disclosures of which are all incorporated herein by reference.

### TECHNICAL FIELD

This disclosure relates generally to systems and methods for restaurant reservation and ordering, and more specifically to systems and methods for discovering restaurants, for searching for specific food items offered by restaurants, for ordering food from restaurants and for making restaurant reservations.

### BACKGROUND

Some websites enable users to book reservations to restaurants. Some websites enable users to order food from restaurants.

### SUMMARY

The present disclosure may comprise one or more of the features recited in the attached claims, and/or one or more of the following features and combinations thereof. In one aspect, a computer-implemented method for at least two of discovering restaurants, booking reservations and ordering food may comprise causing, by a computing system, a remote computing device to display a first user interface that includes at least two of a first user interface element via which a search for restaurants can be performed, a second user interface element via which a search of available restaurant reservations can be performed, and a third user interface element via which a search for restaurants from which food may be ordered remotely can be performed, receiving, by the computing system, an indication of user selection of one of the at least two of the first, second and third user interface elements, causing, by the computing system, the remote computing device to display a user search interface for the selected one of the at least two of the first, second and third user interface elements, receiving, by the computing system, search criteria specified through user interaction with the user search interface for the selected one of the at least two of the first, second and third user interface elements, causing, by the computing system, a display of a list of restaurants that satisfy the specified search criteria, and as a result of receiving input from the user, booking a reservation or placing an order for food with one of the restaurants in the displayed list of restaurants selected by the user.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for discovering restaurants, ordering food and reserving tables.

FIG. 2 is a simplified block diagram of an embodiment of one of the computing devices illustrated in FIG. 1.

FIG. 3 is a simplified block diagram of an embodiment of one of the mobile computing devices illustrated in FIG. 1.

FIG. 4 is a simplified block diagram of at least a portion of a software environment of the RSS server illustrated in FIG. 1.

FIG. 5 is a simplified flowchart illustrating an embodiment of a process for discovering restaurants, searching for specific food items or making restaurant reservations.

FIG. 6 is a simplified flowchart illustrating an embodiment of the restaurant discover process illustrated in FIG. 5.

FIG. 7 is a simplified flowchart illustrating an embodiment of the restaurant selection process illustrated in FIG. 6, in the context of the restaurant discover process.

FIG. 8A is a simplified block diagram of an embodiment of a graphic user interface that may be used to select one or more search filters for refining one or more restaurant and/or food item searches.

FIG. 8B is a simplified block diagram of another embodiment of a graphic user interface that may be used to select one or more search filters for refining one or more restaurant and/or food item searches.

FIG. 8C is a simplified block diagram of yet another embodiment of a graphic user interface that may be used to select one or more search filters for refining one or more restaurant and/or food item searches.

FIG. 8D is a simplified block diagram of still another embodiment of a graphic user interface that may be used to select one or more search filters for refining one or more restaurant and/or food item searches.

FIG. 8E is a simplified block diagram of a further embodiment of a graphic user interface that may be used to select one or more search filters for refining one or more restaurant and/or food item searches.

FIG. 8F is a simplified block diagram of yet a further embodiment of a graphic user interface that may be used to select one or more search filters for refining one or more restaurant and/or food item searches.

FIG. 9 is a simplified block diagram of an example graphic representation of restaurant information for a restaurant selected by a user in the restaurant selection process of FIG. 7.

FIG. 10 is a simplified flowchart illustrating an embodiment of the food item selection process illustrated in FIG. 6, in the context of the restaurant discover process.

FIG. 11A is a simplified flowchart illustrating an embodiment of the ordering process illustrated in FIGS. 7 and 10.

FIG. 11B is a simplified flowchart illustrating an embodiment of the group order process illustrated in FIG. 11A.

FIG. 12 is a simplified flowchart illustrating an embodiment of the restaurant selection process illustrated in FIG. 6, in the context of the restaurant reservation process.

FIG. 13 is a simplified flowchart illustrating an embodiment of the food item selection process illustrated in FIG. 6, in the context of the restaurant reservation process.

FIG. 14 is a simplified flowchart illustrating an embodiment of the reservation process illustrated in FIGS. 12 and 13.

FIG. 15 is a simplified flowchart of a process for switching search result views between “restaurant view” and “food view” modes.

FIG. 16 is a simplified block diagram of an embodiment of a graphic user interface illustrating the “restaurant view” mode of displaying search results.

FIG. 17 is a simplified block diagram of an embodiment of a graphic user interface illustrating the “food view” mode of displaying search results.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

Definitions: The term “restaurant” as used herein means any establishment having a dedicated web page and from which prepared food may be purchased in the form of takeout (i.e., carry out), delivered and/or dine-in food items. The term “takeout” as used herein means receipt by one or more customers from a restaurant, at a geographical location of the restaurant, of one or more food items prepared or otherwise provided by the restaurant in response to a request or order for such one or more food items and in exchange for payment thereof, with at least one of the one or more prepared food items packaged by the restaurant for transport. The term “takeout,” in the context of one or more food items, will be understood to be synonymous with conventional terms such as “carry out,” and “to go” food items. The term “delivery,” as used herein means receipt by one or more customers from a restaurant, at one or more geographical locations separate and apart from the restaurant and specified by the one or more customers, of one or more food items prepared or otherwise provided by the restaurant in response to a request or order for such one or more food items and in exchange for payment thereof. The terms “table reservation,” “restaurant reservation,” “reserve a table” and the like as used herein mean an agreement, typically but not exclusively verbal, between at least one individual and a restaurant that the at least one individual and/or one or more persons identified by the at least one individual will be accommodated by the restaurant to dine at the restaurant at an agreed upon time on an agreed upon calendar date.

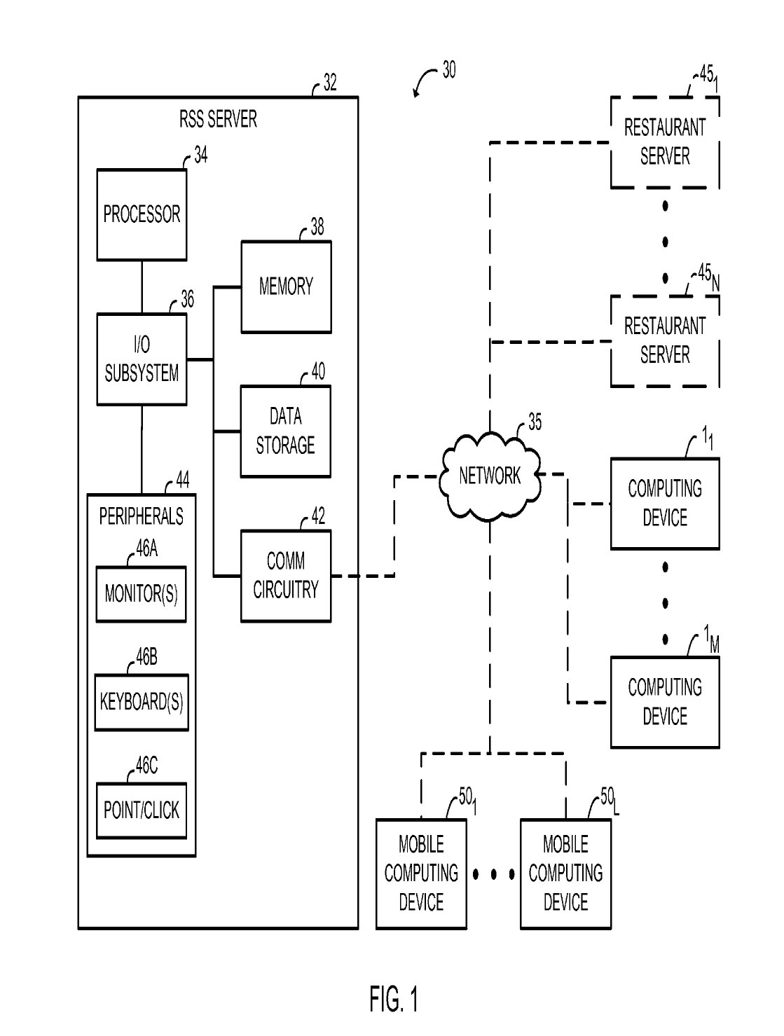

Referring now to FIG. 1, a system 30 for discovering restaurants, ordering food and reserving tables at restaurants is shown. Generally, the system 30 includes and implements techniques, methods, systems, and other mechanisms for discovering, e.g., by searching via a computing device, restaurants for which dedicated websites exist and are maintained, for booking table reservations at any such restaurants and/or for placing food orders with any such restaurants for delivery or takeout. In one aspect, a single website running on the system 30 may provide users of the system 30 with an integrated user experience which enables a user to individually and interchangeably access multiple different dining option features. In one embodiment, for example, a single website may enable a user to separately and/or interchangeably order food for delivery or take out and book reservations at each of multiple restaurants. In other embodiments, a single website can enable a user to separately and/or interchangeably discover restaurants, to order food for delivery or take out and/or to book reservations for each of multiple restaurants. In still other embodiments, a single website may enable a user to separately and/or interchangeably access more, fewer and/or different dining option features. In another aspect, the website may enable users to perform a search for restaurants that offer a specific dish or food item. In still another aspect, the website may enable multiple users, e.g., in accordance with a “group order” feature, to collaborate in a food ordering process from separate computing devices such that food orders from each of the multiple users are provided to a single restaurant for preparation as a single food order for subsequent delivery or takeout. The website can provide restaurant owners and employees access to information on orders and reservations that are placed by customers, and can further provide restaurant owners and customers to co-participate in restaurant and/or food item reviews.

In the embodiment illustrated in FIG. 1, the system 30 includes a restaurant searching system (RSS) server 32 configured to communicate with users of the restaurant searching system 30 via a network 35, and users may access the network 35 using any conventional network accessible electronic device and/or system. In the illustrated embodiment, for example a number, L, of mobile computing devices 50₁-50_{L}, and a number, M, of computing devices 1₁-1_{M}, are shown. Each is configured to communicatively connect to the network 35, and L and M may each be any positive integer. In some embodiments, the system 30 may include a number of restaurant servers 45₁-45_{N}, each of which may operate in a conventional manner to host and maintain a dedicated website for a corresponding restaurant or set of restaurants, e.g., group, chain or franchise of restaurants. Other embodiments may not include such restaurant servers 45₁-45_{N}, and they are therefore shown in FIG. 1 with dashed-line representation. In embodiments that include the restaurant servers 45₁-45_{N}, communications between the RSS server 32 and the restaurant servers 45₁-45_{N} may be accomplished via the network 35.

In some implementations, the RSS server 32 is configured to implement the restaurant searching system in the form of a website (hereinafter referred to, at times, as a restaurant searching website) hosted and maintained on and by the RSS server 32. For example, a user may launch a web browser application program on a computing device 1₁-1_{M} and/or 50₁-50_{L} (e.g., a laptop computer, tablet computer, or smartphone), and may select a bookmark or type in the Universal Resource Locator (URL) for the restaurant searching website. As a result, a request is sent to the RSS server 32 which provides information (e.g., an HTML file) to the user's computing device 1₁-1_{M} and/or 50₁-50_{L} for generating a display of the restaurant searching website.

The document hereinafter refers to interactions with one or more graphical user interfaces of the restaurant searching website generated by the RSS server 32, but it should be understood that many of these interactions involve the user's computing device 1₁-1_{M} and/or 50₁-50_{L} identifying the user input and sending information to the RSS server 32 that indicates the type of user input that was provided. As a result, the RSS server 32 may send to the computing device 1₁-1_{M} and/or 50₁-50_{L} a new webpage to replace the display of the previously-displayed webpage, or may send a command for modifying the display of the existing webpage (e.g., a AJAX command).

The RSS server 32 may be embodied as any type of server (e.g., a web server) or similar computing device capable of performing the functions described herein. In some embodiments, the RSS server 32 is a single server, and in other embodiments the RSS server 32 may be or include multiple servers. In the illustrative embodiment of FIG. 1, the RSS server 32 includes a processor 34, an I/O subsystem 36, a memory 38, a data storage 40, a communication circuitry 42, and one or more peripheral devices 44. It should be appreciated that the RSS server 32 may include other components, sub-components, and devices commonly found in a sever and/or computing device but which are not illustrated in FIG. 1 for clarity of the description.

The processor 34 of the RSS server 32 may be embodied as any type of processor capable of executing software/firmware, such as a microprocessor, digital signal processor, microcontroller, or the like. The processor 34 may be a single processor or include multiple processors. The I/O subsystem 36 of the RSS server 32 may be embodied as circuitry and/or components to facilitate input/output operations with the processor 34 and/or other components of the RSS server 32. The processor 34 is communicatively coupled to the I/O subsystem 36.

The memory 38 of the user RSS server 32 may be embodied as or otherwise include one or more conventional volatile and/or non-volatile memory devices. The memory 38 is communicatively coupled to the I/O subsystem 36 via a number of signal paths. Although only a single memory device 38 is illustrated in FIG. 1, the RSS server 32 may include additional memory devices in other embodiments. Various data and software may be stored in the memory 38. The data storage 40 is also communicatively coupled to the I/O subsystem 36 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 42 of the RSS server 32 may include any number of devices and circuitry for enabling communications between the RSS sever 32 and the one or more computing devices 1₁-1_{M}, the one or more mobile computing devices 50₁-50_{L}, and the one or more restaurant servers 45₁-45_{N} (in embodiments that include the one or more restaurant servers 45₁-45_{N}). In the illustrated embodiment, for example, communication between the RSS server 32 and the one or more computing devices 1₁-1_{M}, the one or more mobile computing devices 50₁-50_{L}, and the one or more restaurant servers 45₁-45_{N} (in embodiments that include the one or more restaurant servers 45₁-45_{N}) takes place wirelessly via the network 35, wherein the network 35 may represent, for example, a public local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the RSS server 32 and at least one of the one or more computing devices 1₁-1_{M}, the one or more mobile computing devices 50₁-50_{L}, and the one or more restaurant servers 45₁-45_{N} (in embodiments that include the one or more restaurant servers 45₁-45_{N}) may be a private network and/or may be, in whole or in part, a wired connection. Generally, the communication circuitry 42 may be configured to use any one or more, or combination, of conventional secure and/or unsecure communication protocols to communicate with the one or more computing devices 1₁-1_{M}, the one or more mobile computing devices 50₁-50_{L}, and the one or more restaurant servers 45₁-45_{N} (in embodiments that include the one or more restaurant servers 45₁-45_{N}). As such, the network 35 may include any number of additional devices, such as additional computers, routers, and switches, to facilitate such communications.

In some embodiments, the RSS server 32 may also include one or more peripheral devices 44. Such peripheral devices 44 may include any number of additional input/output devices, interface devices, and/or other peripheral devices. For example, the peripheral devices 44 may include one or more display monitors 46A, one or more keyboards 46B, one or more point-and-click devices 46C, e.g., mouse, and/or other input/output devices.

The mobile computing devices 50₁-50_{L} illustrated in FIG. 1 are intended to depict mobile computing devices that are each separately owned and/or operated by a different user. No limit on the total number of such mobile computing devices that may be owned and operated by any one user, or on the total number of such mobile computing devices that may communicate with the RSS server 32, is intended or should be inferred. The mobile computing devices 50₁-50_{L} may be or include any mobile electronic device capable of executing one or more software application programs and of communicating with the RSS server 32 via the network 35. Examples of the mobile computing devices 50₁-50_{L} include, but should not be limited to, mobile telephones, smart phones, tablet computers, personal data assistants (PDAs), and the like.

The user computing devices 1₁-1_{M} illustrated in FIG. 1 are intended to include any of privately owned and accessed computers, such as those residing in users' residences or otherwise in possession of users, to include semi-privately owned and accessed computers, such as those residing at multiple-employee business enterprises, and publicly accessible computers, such as those available at internet cafés and kiosks. The user computing devices 1₁-1_{M} may be or include any computer capable of executing one or more software programs and of communicating with the RSS server 32 via the network 32. Examples of the user computing devices 1₁-1_{M} include, but should not be limited to, personal computers (PCs), laptop computers, notebook computers and the like, whether or not networked with one or more other computing devices.

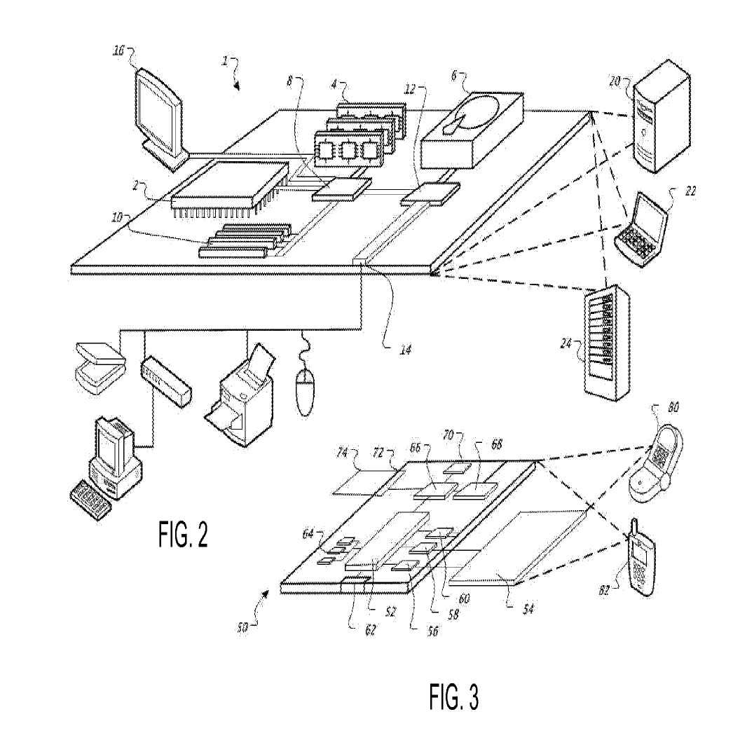

Referring now to FIG. 2, a block diagram is shown of an example embodiment of one of the user computing devices 1 illustrated in FIG. 1. The user computing device 1 is intended to represent various forms of digital computers, such as laptops, desktops, workstations, personal digital assistants, servers, blade servers, mainframes, and other appropriate computers. The components shown here, their connections and relationships, and their functions, are meant to be examples only, and are not meant to limit implementations described and/or claimed in this document.

The user computing device 1 illustratively includes a processor 2, a memory 4, a storage device 6, a high-speed interface 8 connecting to the memory 4 and high-speed expansion ports 10, and a low speed interface 12 connecting to a low speed bus 14 and the storage device 6. Each of the components 2, 4, 6, 8, 10, and 12, are interconnected using various busses, and may be mounted on a common motherboard or in other manners as appropriate. The processor 2 can process instructions for execution within the user computing device 1, including instructions stored in the memory 4 or on the storage device 6 to display graphical information for a GUI on an external input/output device, such as display 16 coupled to a high-speed interface 8. In other implementations, multiple processors and/or multiple buses may be used, as appropriate, along with multiple memories and types of memory. Also, multiple computing devices 1 may be connected, with each device providing portions of the necessary operations (e.g., as a server bank, a group of blade servers, or a multi-processor system).

The memory 4 stores information within the user computing device 1. In one implementation, the memory 4 is a volatile memory unit or units. In another implementation, the memory 4 is a non-volatile memory unit or units. The memory 4 may also be another form of computer-readable medium, such as a magnetic or optical disk. The storage device 6 is capable of providing mass storage for the user computing device 1. In one implementation, the storage device 6 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer- or machine-readable medium, such as the memory 4, the storage device 6, or memory on the processor 2.

The high-speed controller 8 manages bandwidth-intensive operations for the user computing device 1, while the low speed controller 12 manages lower bandwidth intensive operations. Such allocation of functions is by way of example only. In one implementation, the high-speed controller 8 is coupled to the memory 4, the display 16 (e.g., through a graphics processor or accelerator), and to high-speed expansion ports 10, which may accept various expansion cards (not shown). In the illustrated implementation, the low speed controller 12 is coupled to the storage device 6 and the low-speed expansion port 14. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

In one implementation, a computer program product is tangibly embodied in an information carrier. The computer program product contains instructions that, when executed, perform one or more methods, such as those described herein. The information carrier is a computer- or machine-readable medium, such as the memory 4, storage device 56, or memory on processor 2 that may be received, for example, over a transceiver or external interface.

The user computing device 1 may be implemented in a number of different forms, as shown in FIG. 2. For example, it may be implemented as a standard server 20, or multiple times in a group of such servers. It may also be implemented as part of a rack server system 24. In addition, it may be implemented in a personal computer such as a laptop computer 22. Alternatively, components from the user computing device 1 may be combined with other components in a mobile device (not shown), such as device 50. Each of such devices may contain one or more of the user computing device 1 and a mobile computing device 50, and an entire system may be made up of multiple computing devices 1, 50 communicating with each other.

Referring now to FIG. 3, a block diagram is shown of an example embodiment of one of the mobile computing devices 50 illustrated in FIG. 1. The mobile computing device 50 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

The mobile computing device 50 includes a processor 52, a memory 64, an input/output device such as a display 54, a communication interface 66, and a transceiver 68, among other components. The device 50 may also be provided with a storage device, such as a microdrive or other device, to provide additional storage. Each of the components 50, 52, 64, 54, 66, and 68, are interconnected using various buses, and several of the components may be mounted on a common motherboard or in other manners as appropriate.

The processor 52 can execute instructions within the computing device 50, including instructions stored in the memory 64. The processor may be implemented as a chipset of chips that include separate and multiple analog and digital processors. Additionally, the processor may be implemented using any of a number of architectures. For example, the processor 52 may be a CISC (Complex Instruction Set Computers) processor, a RISC (Reduced Instruction Set Computer) processor, or a MISC (Minimal Instruction Set Computer) processor. The processor 52 may provide, for example, for coordination of the other components of the device 50, such as control of user interfaces, applications run by the device 50, and wireless communication by the device 50.

The processor 52 may communicate with a user through a control interface 58 and a display interface 56 coupled to a display 54. The display 54 may be, for example, a TFT (Thin-Film-Transistor Liquid Crystal Display) display or an OLED (Organic Light Emitting Diode) display, or other appropriate display technology. The display interface 56 may comprise appropriate circuitry for driving the display 54 to present graphical and other information to a user. The control interface 58 may receive commands from a user and convert them for submission to the processor 52. In addition, an external interface 62 may be provided in communication with the processor 52, so as to enable near area communication of the device 50 with other devices. An external interface 62 may provide, for example, for wired communication in some implementations, or for wireless communication in other implementations, and multiple interfaces may also be used.

The memory 64 stores information within the mobile computing device 50. The memory 64 can be implemented as one or more of a computer-readable medium or media, a volatile memory unit or units, or a non-volatile memory unit or units. An expansion memory 74 may also be provided and connected to the device 50 through the expansion interface 72, which may include, for example, a SIMM (Single In Line Memory Module) card interface. Such expansion memory 74 may provide extra storage space for the device 50, or may also store applications or other information for device 50. Specifically, the expansion memory 74 may include instructions to carry out or supplement the processes described herein, and may include secure information also. Thus, for example, the expansion memory 74 may be provided as a security module for the device 50, and may be programmed with instructions that permit secure use of the device 50. In addition, secure applications may be provided via the SIMM cards, along with additional information, such as placing identifying information on the SIMM card in a non-hackable manner.

The memory may include, for example, flash memory and/or NVRAM memory, as discussed herein. In one implementation, a computer program product is tangibly embodied in an information carrier. The computer program product contains instructions that, when executed, perform one or more methods, such as those described herein. The information carrier is a computer- or machine-readable medium, such as the memory 64, expansion memory 74, or memory on the processor 52 that may be received, for example, over transceiver 68 or external interface 62.

The device 50 may communicate wirelessly through a communication interface 66, which may include digital signal processing circuitry where necessary. The communication interface 66 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver 68. In addition, short-range communication may occur, such as using a Bluetooth, WiFi, or other such transceiver (not shown). In addition, a GPS (Global Positioning System) receiver module 70 may provide additional navigation- and location-related wireless data to the device 50, which may be used as appropriate by applications running on the device 50.

The device 50 may also communicate audibly using an audio codec 60, which may receive spoken information from a user and convert it to usable digital information. The audio codec 60 may likewise generate audible sound for a user, such as through a speaker, e.g., in a handset of the device 50. Such sound may include sound from voice telephone calls, may include recorded sound (e.g., voice messages, music files, etc.) and may also include sound generated by applications operating on device 50.

The computing device 50 may be implemented in a number of different forms, some of which are shown in FIG. 3. For example, it may be implemented as a cellular telephone 80. It may also be implemented as part of a smartphone 82, personal digital assistant, or other similar mobile device.

Additionally the user computing device 1 and/or the mobile computing device 50 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network) as described above.

The computing system can include clients and servers. A client and server are generally remote from each other and typically interact through a communication network. The relationship of client and server arises by virtue of computer programs running on the respective computers and having a client-server relationship to each other.

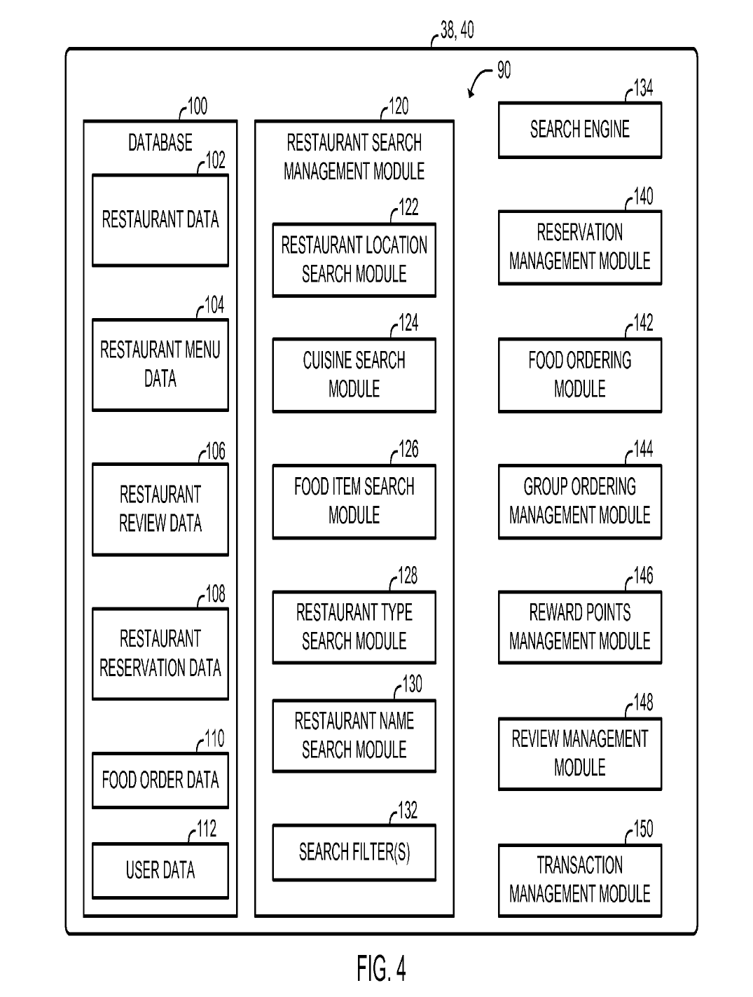

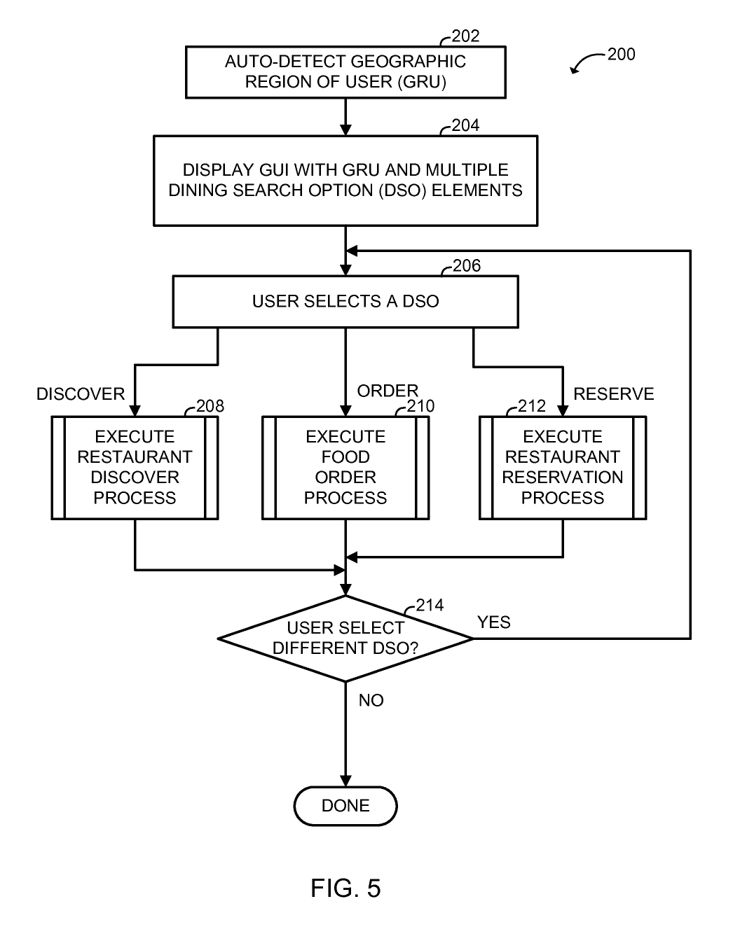

Referring now to FIG. 4, a simplified block diagram is shown of a software environment 90 of the RSS server 32. In the illustrated embodiment, some of the items may be stored, in whole or in part, in the memory 38 of the RSS server 32, and/or some may be stored, in whole or in part, in the data storage 40 of the RSS server 32. In alternate embodiments, the system 30 may include remote data storage that is accessible to the RSS server 32, and in such embodiments one or more of the items illustrated in FIG. 4 may be stored, in whole or in part, in such remote data storage. In any case, some of the items illustrated in FIG. 4 represent instructions which, when executed by the processor 34 of the RSS server 32, result in the processor 34 performing the various functions described herein. Some such instructions, and the resulting functions performed by the processor 34 as a result of execution thereof, will be described in detail hereinafter with respect to FIGS. 5-13.

In the embodiment illustrated in FIG. 4, the environment 90 includes a database 100 in which is stored restaurant data 102, restaurant menu data 104, restaurant review data 106, restaurant reservation data 108, food order data 110 and user data 112. The restaurant data 102 illustratively includes information for each of a plurality of restaurants in each of a plurality of geographical areas. No limit should be understood or implied with respect to the number of restaurants and/or geographical areas for which restaurant identification may be stored in the database 100. In embodiments that include the one or more restaurant servers 45₁-45_{N}, the information for each restaurant may illustratively include at least a Universal Resource Locator (URL) of a dedicated website hosted and maintained by or on behalf of the restaurant. As a result of a request sent by the RSS server 32 of any such URL via the network 35, information (e.g., an HTML file) may be sent by a corresponding one of the restaurant servers 45₁-45_{N} to the RSS server 32 for granting access to, such as by generating a display of, the website of the corresponding restaurant. In such embodiments, the restaurant data 102 may be determined or supplemented via communications with the RSS server 32 over the network 35. In any case, the restaurant data 102 may alternatively or additionally include the names, addresses, telephone numbers, email addresses and/or other information of each of the plurality of restaurants.

The restaurant menu data 104 illustratively includes electronically storable menus, e.g., digital menus, of food items offered by each of the plurality of restaurants. In embodiments that include the one or more restaurant servers 45₁-45_{N}, the RSS server 32 may be operable to periodically access the websites of each of the plurality of restaurants for updated digital menus. In other embodiments, such restaurant menus and all restaurant data is created dynamically using data stored for each restaurant in the RSS server 32, and all restaurant information is therefore resident in the RSS server 32.

The user data 112 illustratively includes data for each of the number of users of the restaurant searching website. In some embodiments, all such users are required to register with the RSS server 32 to gain access to the restaurant searching website. In other embodiments, some users may gain access as guests to a limited set of features offered by the restaurant searching website, while access to additional features offered by the restaurant may be reserved for registered users. In any case, the user data 112 illustratively includes identifying information for each such user, such as name, address, email address and/or telephone/cellular phone number. In some embodiments, the restaurant searching website may include a social media feature via which users may establish connections with other users, e.g., “friends,” and in such embodiments the user data 112 may further include identifying information for each user's network of friends as well as data for any clubs, subgroups and/or other features offered by the social media feature. In some embodiments, as will be described in detail below, users may order food from restaurants using the restaurant searching website, and users may pre-pay for some such food orders using an electronic form of payment, e.g., credit card, debit card, pay pal, etc. In such embodiments, the user data 112 may further include identifying information, e.g., securely stored in the database 100, for one or more such electronic forms of payment associated with corresponding users. In other embodiments, credit card and/or other electronic payment information is stored in a third party secure system. Those skilled in the art will recognize other user information that may be stored in the user data 112, and it will be understood that any such other user information is intended to fall within the scope of this disclosure.

The restaurant review data 106 illustratively includes data files of restaurant reviews written by users of the restaurant searching website and/or commented upon by other users of the restaurant searching website and/or commented upon by the owners/managers/employees of the various restaurants. Such data files are illustratively stored in a manner that associates all such reviews and/or comments with a corresponding one of the restaurants stored in the restaurant data 102 and with corresponding ones of the users of the restaurant searching website.

The restaurant reservation data 108 illustratively includes data files of future, current and, in some embodiments, past table reservations made by users of the restaurant searching website. Such data files are illustratively stored in a manner that associates all such reservations with a corresponding one of the restaurants stored in the restaurant data 102 and with corresponding ones of the users of the restaurant searching website.

The food order data 110 illustratively includes data files of future, current and, in some embodiments, past food orders placed by users of the restaurant searching website. Such data files are illustratively stored in a manner that associates all such food orders with a corresponding one of the restaurants stored in the restaurant data 102 and with corresponding ones of the users of the restaurant searching website.

The software environment 90 further includes a restaurant search management module 120 operable to manage user searches for restaurants using the restaurant searching website. In the illustrated embodiment, the restaurant search management module 120 includes a restaurant location search module 122, a cuisine search module 124, a food item search module 126, a restaurant type search module 128, a restaurant name search module 130 and a number of different search filters 132. The restaurant location search module is illustratively operable to facilitate searching of restaurants by geographical information provided to the RSS server 32 by users of the restaurant searching website. The geographical information may include, for example, city, state, county, country, providence, street address and/or zip code.

The cuisine search module 124 is illustratively operable to facilitate searching of restaurants by cuisines in which restaurants may specialize. In such embodiments, cuisines in which restaurants specialize will typically be included in the restaurant data 102 and/or will be discoverable by the RSS server 32 by accessing such information from restaurant websites. In any case, example cuisines by which users may conduct restaurant searches include, but are not limited to, American, Chinese, Italian, African, Mexican, Japanese, French, Moroccan, Brazilian, German, Indian, Ethiopian, Peruvian, Middle Eastern, British, Caribbean, Thai, European, New England, Vietnamese, Spanish, Nuevo Latino, Asian and Turkish.

The food item search module 126 is illustratively operable to facilitate searching of restaurants by description of food items offered by the restaurants. Such food item descriptions may illustratively vary in specificity, although the more specific the description the higher likelihood of finding a restaurant that offers the specific food item in which a user may be interested. In any case, specific food items offered by restaurants will typically be included in the restaurant menu data 104 and/or will be discoverable by the RSS server 32 by accessing such menu data from restaurant websites.

It will be understood that such food item searching is independent of cuisine, restaurant type or other tags or filters that may be used to categorize or otherwise identify restaurants. For purposes of this disclosure, the term “food item” may be or include a specific item of food, e.g., “Cobb Salad,” or a more general meal term, e.g., “Salad.” In the former case, the search results will include only those restaurants that offer Cobb Salads, whereas the search results in the latter case will include restaurants that offer any type of salad. It will be understood in any case that searching by food item may in many cases offer more choices than searching by other criteria. For example, if a user interested in Pad Thai selects “Asian” or “Thai” as a cuisine search criteria, the search results will include only Asian or Thai restaurants, some of which may or may not include Pad Thai as an available food item. If instead the user enters “Pad Thai” as the search criteria, the search results will include all restaurants in the selected geographical area that offer Pad Thai, regardless of whether such restaurants are tagged or otherwise identified as “Asian” or “Thai.” The latter search may accordingly produce more Pad Thai options than the former search results.

The restaurant type search module is illustratively operable to facilitate searching of restaurants by “restaurant type,” which is defined for purposes of this disclosure as any one or combination of atmosphere, dining experience, customer demographic, features and/or amenities. In such embodiments, the restaurant type will typically be included in the restaurant data 102 and/or restaurant menu data 104, and/or restaurant review data 106, and/or will be discoverable by the RSS server 32 by accessing such information from restaurant websites. In any case, example restaurant types by which users may conduct restaurant searches include, but are not limited to, casual dining, fine dining, bar/pub, buffet, café, tea house, particularly suited for dates, business meetings, groups, children, or singles, and availability of live music, outdoor seating, gaming, wheelchair accessibility, happy hour, extended hours, e.g., open 24 hours, abundant parking, Wi-Fi, prix-fixe meals, availability of certain alcoholic beverages such as beer, wine and/or spirits, non-availability of alcoholic beverages, bring-your-own alcoholic beverages, and raw bar.

The restaurant name search module is illustratively operable to facilitate searching of restaurants by restaurant names provided by users to the RSS server 32 via the restaurant searching website. In such embodiments, restaurant names will typically be included in the restaurant data 102 and/or restaurant menu data 104, and/or restaurant review data 106, and/or will be discoverable by the RSS server 32 by accessing such information from restaurant websites.

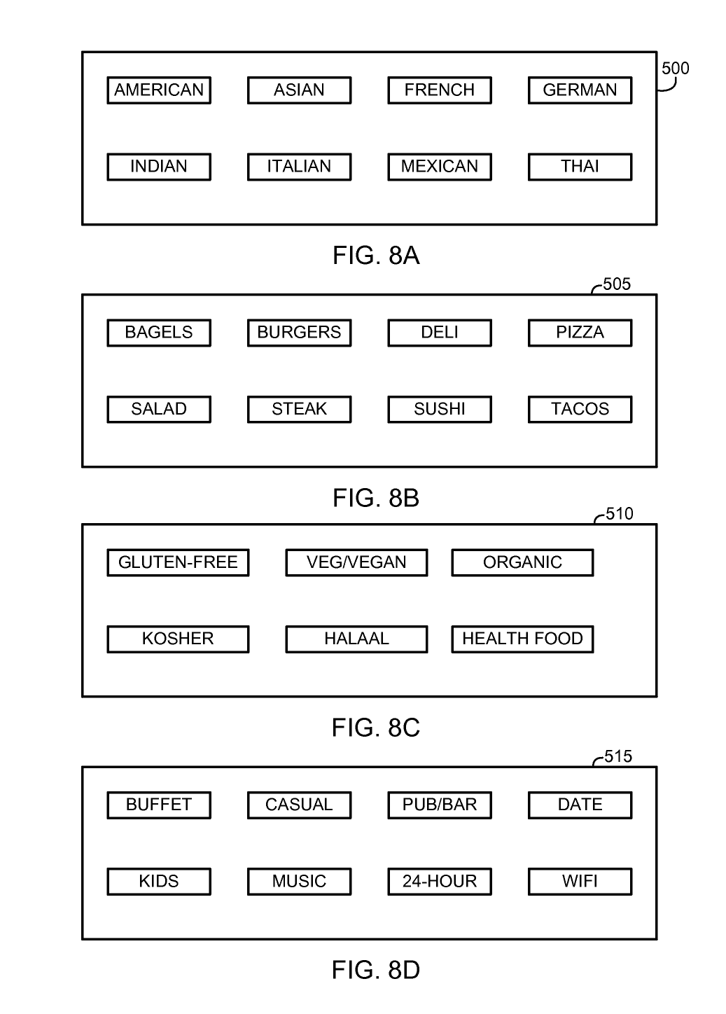

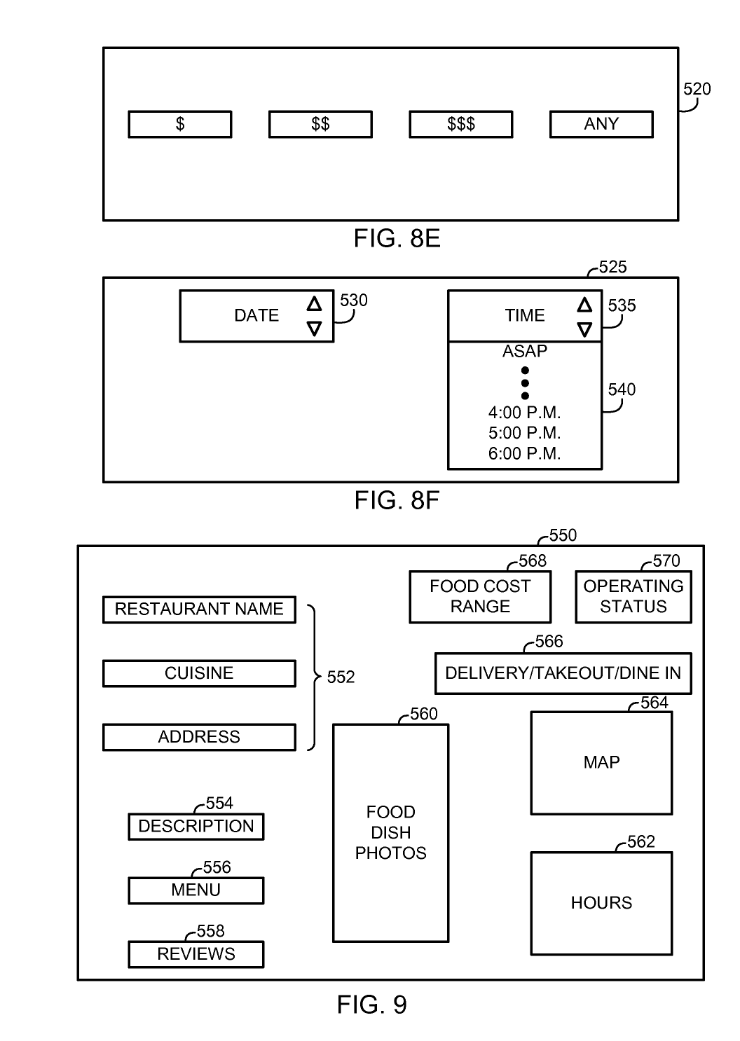

The search filters 132 may illustratively include any number of filters via which user searches may be refined. In some embodiments, any of the above described search modules may alternatively or additionally be used as a search filter to refine user searches based on other search criteria. Thus, for example, users in some embodiments may refine search results by specifying one or more of geographic location, cuisine, specific food item, restaurant type and/or restaurant name. Additional search filters may illustratively include, but are not limited to, food cost range, food type, food category (e.g., content or lack of content). Examples of some such search filters will be described in greater detail below with respect to FIGS. 8A-8E.

The software environment 90 illustrated in FIG. 4 further illustratively includes a search engine 134 operable to conduct restaurant and/or food item searches based on user-specified search criteria provided by users to the RSS server 32 via the restaurant searching website. A reservation management module 140 is operable to manage reservations made by users at various restaurants via the restaurant searching website. A food ordering module 142 is operable to manage ordering of food from restaurants by users via the restaurant searching website. A group ordering management module 144 is operable to manage combined food orders made by a user and at least one additional individual at a specified restaurant via the restaurant searching website.

A reward points management module 146 is operable to award points for using the restaurant searching website. In one embodiment, such points may be awarded to all members of a group order, and in other embodiments such points may be offered only to individuals who pay for one or more food orders. In any case, the points may be awarded based on one or any combination of total amount spent for the order, choice of restaurant, choice of restaurant type, choice of menu item(s) ordered, choice of cuisine, choice of food content (or lack of content), and the like. The points may illustratively be redeemed with the restaurant searching website for one or more rewards, examples of which include, but are not limited to, food discounts, food or restaurant deals, e.g., 2-for-1 meals or meal items, free desert or side item, free drink, free drink refills, etc., exclusive food or restaurant perks, e.g., preferential table reservation dates, days of the week and/or times of day, and the like. It will be understood that points may awarded for using the restaurant searching website in the context of group ordering and single-person ordering, and/or for other uses of the restaurant searching website. Apart from money transactions, points may also be awarded for user actions sought to be encouraged, such as for writing reviews, uploading photos, inviting friends, bookmarking, sharing, point out errors, etc.

A review management module 148 is operable to manage restaurant reviews generated by users of the restaurant searching website and commented upon by other users and/or restaurant owners/managers/employees. Illustratively, the review management module 148 is operable to post such reviews and comments on restaurant pages generated by the restaurant searching website, and to store such reviews and comments in the database 106 in a manner that associates the reviews and comments with corresponding restaurants and users.

A transaction management module 150 is operable to manage payment transactions made by users in payment of food orders placed by users with one or more restaurants. Illustratively, the transaction management module 150 is operable to process such payment transaction using one or more forms of electronic payment, e.g., credit card, debit card, pay pal, etc., identified and stored by users in the database 100, e.g., in the user data 112, or in a third party secure system.

Referring now to FIG. 5, a flowchart is shown of an embodiment of a process 200 for discovering restaurants, searching for specific food items and/or making restaurant reservations. The process 200 is illustratively stored in the memory 38 and/or data storage 40 of the RSS server 32 in the form of instructions executable by the processor 34 to cause the processor 34 to carry out the corresponding functionality. As previously described, the restaurant searching system 30 is illustratively implemented in the form of a restaurant searching website hosted and managed by the RSS server 32 and accessed by users of the restaurant searching website via user computing devices 1₁-1_{M} and/or via user mobile computing devices 50₁-50_{L}. In this regard, some of the functions carried out by the processor 34 in the process 200 (as well as in the process illustrated in the remaining Figures) involve generating various graphic user interfaces (GUI) which will be displayed on display monitors or screens of such user computing devices 1₁-1_{M} and/or via user mobile computing devices 50₁-50_{L}, while other functions carried out by the processor 34 in the process 200 involve acting upon information entered by users into one or more such GUIs and/or information selected by users within one or more such GUIs.

The process 200 illustratively begins at step 202 where, upon access by a user of the restaurant searching website, the processor 34 automatically detects the geographic region of the user (GRU). In some embodiments, the GRU includes the city and state in which the user is located, although in other embodiments the GRU may include more, less and/or different geographic location information of the user. The processor 34 may use any conventional device(s) and/or technique(s) for determining the GRU, examples of which include, but are not limited to, processing the user's internet protocol (IP) address to determine the city and state in which the user's computing device is located, processing GPS information captured by a GPS unit on-board the user's computing device, and the like. In other embodiments, the user may be prompted at step 202 to enter the user's location, e.g., city and state, whereupon the processor 34 is operable to store this information in the form of a cookie such that on subsequent visits the automatic location determination may be bypassed and the user's location may be determined by the stored cookie until manually changed by the user.

In any case, following step 202 the process 200 advances to step 204 where the processor 34 is operable to generate for display on the user's computing device a GUI which includes the GRU and which also includes multiple dining search option (DSO) elements. In one embodiment, the GUI generated at step 204 includes two DSO elements “order” and “reserve,” via which a user may correspondingly search for restaurants in the GRU or elsewhere at which to order food and/or reserve a table. In another embodiment, such as illustrated by example in FIG. 5, the GUI generated at step 204 includes 3 DSO elements “Discover,” “Order” and “Reserve,” via which a user may correspondingly search for restaurants in the GRU or elsewhere to investigate, peruse and/or consider for food choices, search for restaurants at which to order food, and/or search for restaurants at which to make a table reservation. Those skilled in the art will recognize that the GUI generated at step 204 may include more, fewer and/or different DSO elements for use separately or integrally by users, and any such number and functionality of DSO elements are intended to fall within this scope of this disclosure. In any case, the DSO elements may illustratively be provided in the form of selectable GUI tabs or icons, although other forms of GUI elements may alternatively be used.

The process 200 advances from step 204 to step 206 where the user selects, via the user's computing device, a DSO element from the GUI generated by the processor 34 at step 204. If the user selects the “Discover” DSO element at step 206, the process 200 advances to step 208 where the processor 34 is directed to execute a “Restaurant Discover” process. If the user instead selects the “Order” DSO element at step 206, the process 200 advances to step 210 where the processor 34 is directed to execute a “Food Order” process. If the user instead selects the “Reserve” DSO element at step 206, the process 200 advances to step 212 where the processor 34 is directed to execute a “Restaurant Reservation” process. Following execution of any of the various processes at steps 208, 210, 212, the process 200 advances to step 214 where the processor 34 is operable to determine whether the user has selected a different DSO. If so, the process 200 loops back to step 206 where the processor 34 determines which of the steps 208, 210, 212 to advance to based on the new DSO element selected by the user.

As will be described in greater detail below, each of the processes identified by steps 208, 210, 212 illustratively include an escape mechanism via which a user may return to step 214 of the process 200 at will. Accordingly, the user may at any time switch between the “Discover” process, the “Order” process and the “Reserve” process. This feature thus provides for a fluid and adaptable integrated user experience in which the user can change restaurant/food search strategies at will, thereby allowing the user to flow through the search processes in a natural manner as the user contemplates where and/or what they wish to eat.

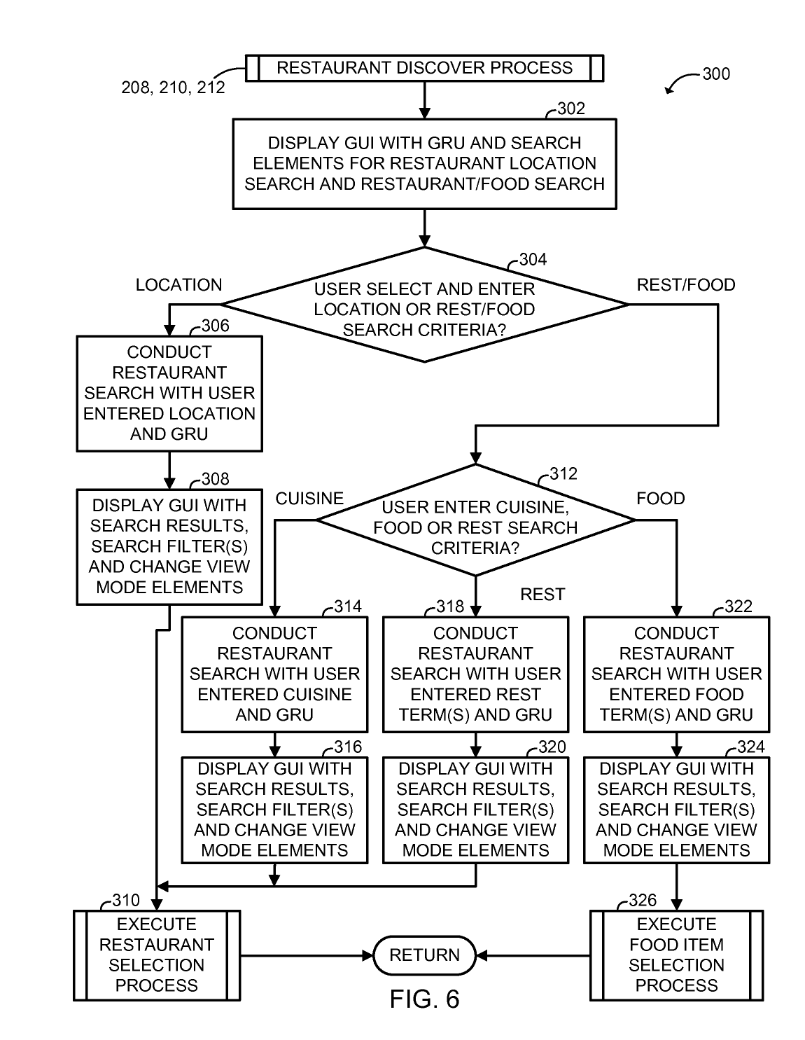

Referring now to FIG. 6, flowchart is shown of an embodiment of a process 300 for discovering restaurants as a result of executing step 208 in the process 200 illustrated in FIG. 5. As with the process 200, the process 300 is illustratively stored in the memory 38 and/or data storage 40 of the RSS server 32 in the form of instructions executable by the processor 34 to cause the processor 34 to carry out the corresponding functionality.

The process 300 illustratively begins at step 302 where the processor 34 is operable to generate for display on the user's computing device a GUI which includes the GRU and which also includes a search element for conducting a restaurant search using geographic location criteria and another search element for conducting a restaurant or food search by restaurant or food criteria. Thereafter at step 304, the processor 34 is operable to determine whether the user has selected and entered location or restaurant/food search criteria. If the user has selected and entered location criteria by selecting the search element for conducting a restaurant search using geographic location criteria and entering such criteria into the corresponding search element of the GUI, the process 200 advances to step 306 where the processor 34 is illustratively operable to conduct, e.g., using the search engine 134, a restaurant search using the user-entered location criteria as well as the GRU. Thus, for example, if the user's GRU is Indianapolis, Ind. and the user enters 82^{nd} Street, the processor 34 will conduct a search at step 306 for restaurants located on and/or near 82^{nd} Street in Indianapolis, Ind. Illustratively, the various GUIs generated by the processor 34 may further include a GUI element via which the user may select a different GRU from that which was automatically detected by the processor 34 at step 202 of the process 200. Accordingly, users may search for restaurants by location at step 306 of the process 300 in any geographical region that is supported by the restaurant searching website, e.g., within one or more countries or globally, simply by specifying a desired GRU using the corresponding GUI element and then entering geographic location criteria into the corresponding search element of the GUI displayed at step 304.

Following step 306, the process 300 advances to step 308 where the processor 34 is operable to generate for display on the user's computing device a GUI which includes the results of the search conducted at step 306 along with one or more of the search filters 132. The search results generated and displayed in the GUI at step 308 include identification of restaurants that match the current GRU and the geographic location criteria entered by the user. The search results may be arranged in various different ways, examples of which include, but are not limited to, by decreasing (or increasing) proximity to the user-entered geographical location criteria, alphabetically, or other arrangement strategy. In any case, the process 300 advances from step 308 to step 310 where the processor 34 is directed to execute a “Restaurant Selection” process, e.g., based on the restaurant search results produced and displayed at step 308.

If, at step 304, the user has selected and entered restaurant/food criteria by selecting the search element for conducting a restaurant or food search by restaurant or food criteria and entering such restaurant or food criteria into the corresponding search element of the GUI, the process 200 advances to step 312 where the processor 34 is operable to determine whether the user has entered cuisine, food or restaurant-related search criteria. If the processor 34 determines that the user has entered cuisine-related search criteria, the process 300 advances to step 314 where the processor 34 is illustratively operable to conduct, e.g., using the search engine 134, a restaurant search using the user-entered cuisine criteria as well as the GRU. Thus, keeping with the same example as above, if the user's GRU is Indianapolis, Ind. and the user enters as the cuisine search criteria “Thai,” the processor 34 will conduct a search at step 306 for restaurants located in Indianapolis, Ind. that specialize in Thai cuisine. Again, the various GUIs generated by the processor 34 may further include a GUI element via which the user may select a different GRU from that which was automatically detected by the processor 34 at step 202 of the process 200. Accordingly, users may search for restaurants by cuisine criteria at step 314 of the process 300 in any geographical region that is supported by the restaurant searching website simply by specifying a desired GRU using the corresponding GUI element and then entering cuisine criteria into the corresponding search element of the GUI displayed at step 316.

Following step 314, the process 300 advances to step 316 where the processor 34 is operable to generate for display on the user's computing device a GUI which includes the results of the search conducted at step 314 along with one or more of the search filters 132. The search results generated and displayed in the GUI at step 316 include identification of restaurants that match within the GRU the cuisine criteria entered by the user. The search results may be arranged in various different ways, examples of which include, but are not limited to, by popularity, by average meal cost (increasing or decreasing), alphabetically, or other arrangement strategy. In any case, the process 300 advances from step 316 to step 310 where the processor 34 is directed to execute the “Restaurant Selection” process, e.g., based on the restaurant search results produced and displayed at step 316.

If, at step 312, the user has entered restaurant-related search criteria, the process 300 advances to step 318 where the processor 34 is illustratively operable to conduct, e.g., using the search engine 134, a restaurant search using the user-entered restaurant criteria as well as the GRU. Thus, keeping with the same example as above, if the user's GRU is Indianapolis, Ind. and the user enters as the restaurant search criteria a restaurant name such as “St. Elmo,” the processor 34 will conduct a search at step 318 for restaurants located in Indianapolis, Ind. named, or that include the name, St. Elmo. As another example, if the user enters as the restaurant search criteria a restaurant type, such as “outdoor seating,” the processor 34 will conduct a search at step 318 for restaurants located in Indianapolis, Ind. named, or that have outdoor seating available. Again, the various GUIs generated by the processor 34 may further include a GUI element via which the user may select a different GRU from that which was automatically detected by the processor 34 at step 202 of the process 200. Accordingly, users may search for restaurants by restaurant criteria at step 318 of the process 300 in any geographical region that is supported by the restaurant searching website simply by specifying a desired GRU using the corresponding GUI element and then entering restaurant criteria into the corresponding search element of the GUI displayed at step 318.

Following step 318, the process 300 advances to step 320 where the processor 34 is operable to generate for display on the user's computing device a GUI which includes the results of the search conducted at step 318 along with one or more of the search filters 132. The search results generated and displayed in the GUI at step 320 include identification of restaurants that match within the GRU the restaurant criteria entered by the user. The search results may be arranged in various different ways, examples of which include, but are not limited to, by popularity, average meal cost (increasing or decreasing), alphabetically, or other arrangement strategy. In any case, the process 300 advances from step 320 to step 310 where the processor 34 is directed to execute the “Restaurant Selection” process, e.g., based on the restaurant search results produced and displayed at step 320.

If, at step 312, the user has entered food-related search criteria, the process 300 advances to step 322 where the processor 34 is illustratively operable to conduct, e.g., using the search engine 134, a restaurant search using the user-entered food criteria as well as the GRU. Once again keeping with the same example as above, if the user's GRU is Indianapolis, Ind. and the user enters as the food search criteria “California Roll” the processor 34 will conduct a search at step 322 for restaurants located in Indianapolis, Ind. that offer a California Roll as a menu item, e.g., that are tagged as offering California Rolls. Again, the various GUIs generated by the processor 34 may further include a GUI element via which the user may select a different GRU from that which was automatically detected by the processor 34 at step 202 of the process 200. Accordingly, users may search for restaurants by food criteria at step 322 of the process 300 in any geographical region that is supported by the restaurant searching website simply by specifying a desired GRU using the corresponding GUI element and then entering food criteria into the corresponding search element of the GUI displayed at step 322.

Following step 322, the process 300 advances to step 324 where the processor 34 is operable to generate for display on the user's computing device a GUI which includes the results of the search conducted at step 322 along with one or more of the search filters 132. The search results generated and displayed in the GUI at step 320 include identification of restaurants that match within the GRU the food criteria entered by the user. In some embodiments, the GUI generated and displayed at step 322 may additionally include with each such restaurant a photo produced by the restaurant of the specified food item. The search results may be arranged in various different ways, examples of which include, but are not limited to, by popularity, average meal cost (increasing or decreasing), alphabetically, or other arrangement strategy. In any case, the process 300 advances from step 324 to step 326 where the processor 34 is directed to execute a “Food Item Selection” process, e.g., based on the restaurant search results produced and displayed at step 324.

Following either of steps 310 and 324, the process 300 returns to the process 200 at step 214 described above. Although not specifically shown in FIG. 6, the process 300 illustratively includes a manual exit mechanism, e.g., a suitable GUI element in each of the GUIs produced in the process 300, which may be selected at any time by the user, the effect of which will be to immediately return the process 300 to step 214 of the process 200 for user selection of a different DSO element, e.g., to conduct a different type of restaurant/food search or restart the restaurant/food search previously being conducted.

Illustratively, the GUIs of the restaurant search results generated at steps 308, 316 and 320 default to “restaurant view” mode in which the search results are arranged by restaurant information, i.e., information specific to the restaurant itself, such as restaurant name, address, photo of one or more dishes offered by the restaurant, etc., whereas the GUI of the restaurant search results generated at step 326 illustratively defaults to a “food view” mode in which the search results are arranged by the selected food item, e.g., by restaurants in the GRU that offer the selected food item, illustratively along with information about that food item, e.g., a photo of the food item, tagged as being offered by each such restaurant in the list. Thus, in the “food view” mode, the restaurants in the list of search results are arranged and viewed according to information about the food items that match the search criteria, whereas in the “restaurant view” mode the restaurants in the list of search results are arranged and viewed according to information about the restaurants themselves.

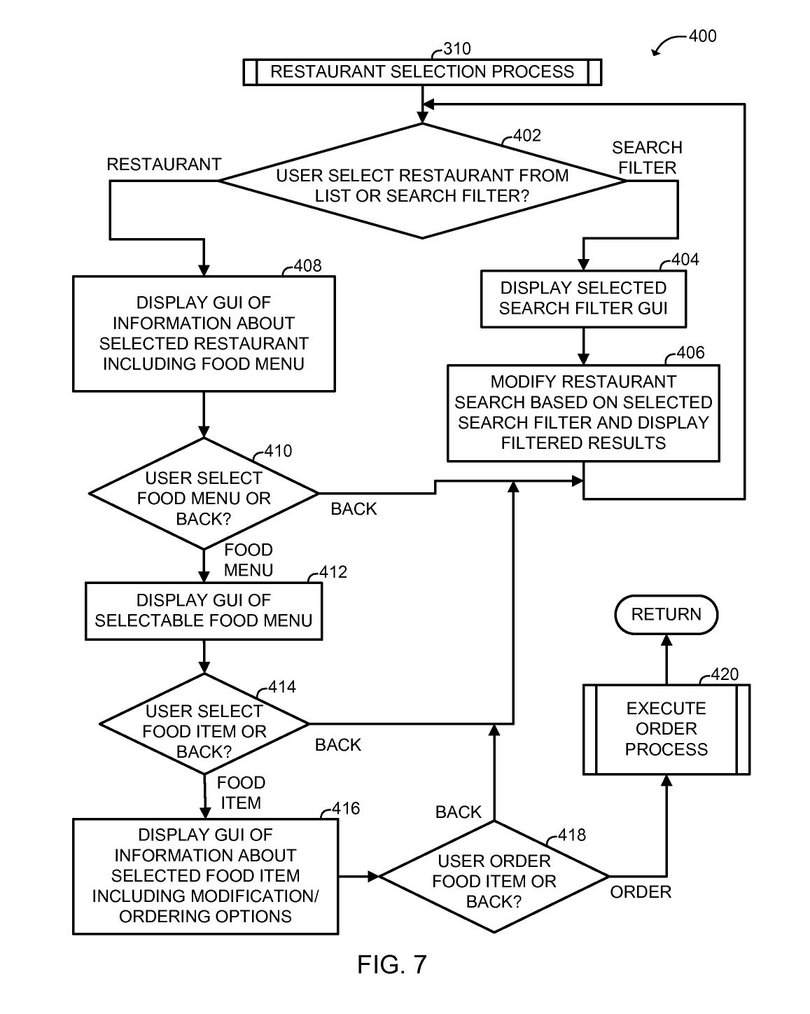

Referring now to FIG. 7, a flowchart is shown of an embodiment of a process 400 for selecting a restaurant from a list of restaurants generated at any of steps 308, 314 and 320 of the process 300 illustrated in FIG. 6. As with the processes 200 and 300, the process 400 is illustratively stored in the memory 38 and/or data storage 40 of the RSS server 32 in the form of instructions executable by the processor 34 to cause the processor 34 to carry out the corresponding functionality.

The process 400 illustratively begins at step 402 where the processor 34 is operable to determine whether the user has selected a restaurant from the list of restaurants generated at any of steps 308, 314 and 320 of the process 300 illustrated in FIG. 6 or whether the user has instead selected one of the search filters 132. If the processor 34 determines at step 402 that the user has selected one of the search filters included in a corresponding one of the GUIs generated at step 308, 314 or 320, the process 400 advances to step 404 where the processor 34 is operable to generate for display on the user's computing device a GUI which displays the selected search filter GUI. Thereafter at step 406, the processor 34 is operable to modify the restaurant search results based on user selection of one of the search filters displayed in the selected search filter GUI.

Referring now to FIGS. 8A-8E, several examples are provided of search filter GUIs that may be selected and displayed at step 404, and from which the user may select a desired search filter element at step 406. Referring first to FIG. 8A, an example cuisine GUI 500 is shown which includes a number of selectable search filter elements for refining the restaurant search results generated by the process 300 by restaurants specializing in one or more selected cuisines. In the illustrated embodiment, the cuisine GUI 500 includes as selectable GUI elements American, Asian, French, German, Indian, Italian, Mexican and Thai. It will be understood that the cuisine GUI 500 may include more, fewer and/or different selectable cuisine GUI elements, a non-exhaustive list of examples of which has been described above.

Referring now to FIG. 8B, an example food category or type GUI 505 is shown which includes a number of selectable search filter elements for refining the restaurant search results generated by the process 300 by restaurants specializing in, or that otherwise offer as purchasable food items, one or food types and/or by restaurants that specialize in one or more food and/or dining categories. In the illustrated embodiment, the food category or type GUI 505 includes as selectable GUI elements Bagels, Burgers, Deli, Pizza, Salad, Steak, Sushi and Tacos. It will be understood that the food category or type GUI 505 may include more, fewer and/or different selectable food category or type GUI elements, additional examples of which include, but are not limited to, sandwiches and/or wraps, bakery, food stands and trucks, weekend brunch, bar food, smoothies and juice bars, ice cream and frozen yogurt, deli, hot dogs, barbeque, beverages and desert.

Referring now to FIG. 8C, an example food style GUI 510 is shown which includes a number of selectable search filter elements for refining the restaurant search results generated by the process 300 by restaurants specializing in, or that otherwise offer as purchasable food items, one or food styles. In the illustrated embodiment, the food style GUI 510 includes as selectable GUI elements Gluten-Free, Vegetarian/Vegan, Organic, Kosher, Halaal and Health Food. It will be understood that the food style GUI 510 may include more, fewer and/or different selectable food category or type GUI elements, an additional example of which includes, but is not limited to, Charcuterie.

Referring now to FIG. 8D, an example restaurant type GUI 515 is shown which includes a number of selectable search filter elements for refining the restaurant search results generated by the process 300 by restaurant type, as this term is defined hereinabove. In the illustrated embodiment, the restaurant type GUI 515 includes as selectable GUI elements Buffet, Casual, Pub/Bar, Date, Kids, Music, 24-hour and WiFi. It will be understood that the restaurant type GUI 515 may include more, fewer and/or different selectable restaurant type GUI elements, a non-exhaustive list of examples of which has been described above.

Referring now to FIG. 8E, an example cost range GUI 520 is shown which includes a number of selectable search filter elements for refining the restaurant search results generated by the process 300 by average cost of dishes offered by the restaurants. In the illustrated embodiment, the cost range GUI 520 includes as selectable elements $, $$, $$$, and Any, where each additional dollar signifies a higher average cost of dishes offered by the restaurants. It will be understood that the cost range GUI 520 may include more, fewer and/or different selectable cost range GUI elements.

Referring now to FIG. 8F, an example date and time filter GUI 525 is shown which includes a number of selectable search filter elements for refining the restaurant search results generated by the process 300 based on date and/or time of a user requested event, such as ordering food, requesting a table reservation, and the like. In the illustrated embodiment, the date and time filter GUI 525 includes as selectable elements a date element 530 and a time element 535. Each may be provided in the form of a pull-down menu such as with the pull-down menu 540 illustrated with respect to the time element 535, or may alternatively be provided in the form of a text box or field. Using the date and time filter 525, a user may, for example, search for delivery restaurants that deliver (or don't deliver) on certain days and/or at certain times. It will be understood that the GUI 525 may include more, fewer and/or different selectable GUI elements.

With any such filters and/or initial search criteria, the processor 34 is illustratively operable in some embodiments to produce restaurant search results based on closest possible matches rather than strictly on exact matches.

Referring again to FIG. 7, the process 400 loops from step 406 back to step 402 after the current restaurant search results have been refined by one or more user-selected search filter elements of a user-selected search filter GUI. At step 402, the user may again select the same or another search filter to further refine the restaurant search results, or may instead select a restaurant from the current list of restaurant search results. If the processor 34 determines the latter to be the case, the process 400 advances to step 408 where the processor 34 is operable to generate for display on the user's computing device a GUI which includes information about the selected restaurant, including a food menu which the user may browse and/or from which the user may order food for delivery or takeout. The GUI may include various information about the selected restaurant, some of which may be selectable by the user and some of which may only be viewed.

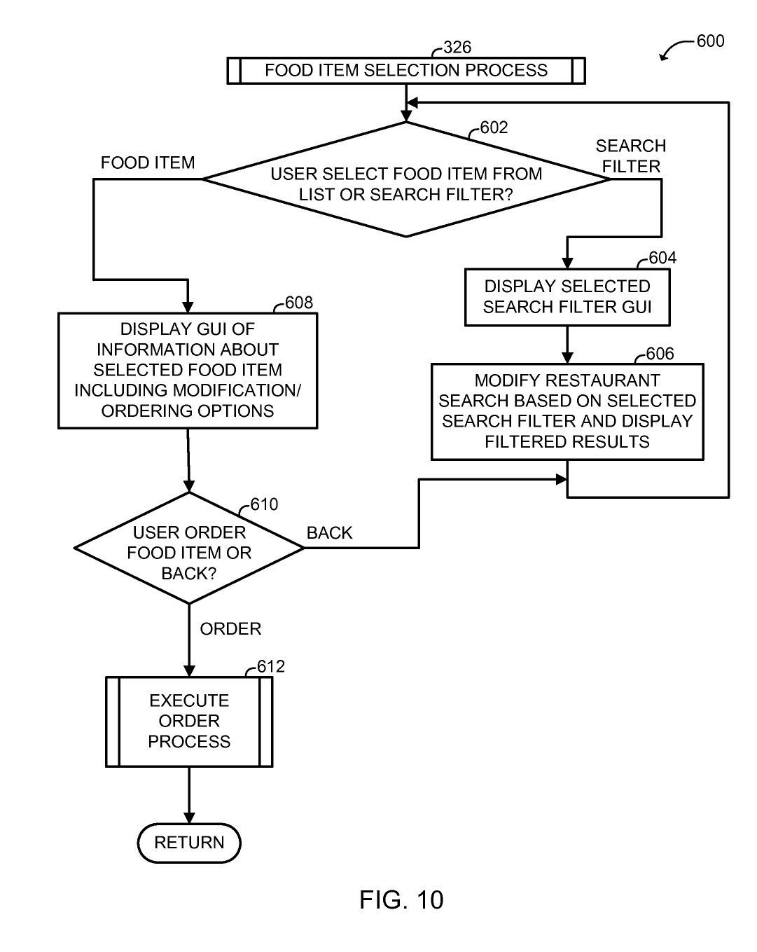

An example GUI 550 illustrating various informational components of a selected restaurant that may be included in the GUI 550 is shown in FIG. 9. Referring to FIG. 9, the GUI 550 of the selected restaurant may illustratively include information 552 identifying the restaurant such as the restaurant name, a cuisine in which the selected restaurant specializes, and/or a street and/or email address of the restaurant. The GUI 550 may include a description 554 of the selected restaurant, e.g., an overview or other details about the restaurant. As described above, the GUI 550 may include a menu 556 of food items offered by the selected restaurant which the user may browse and from which the user may select a food item for delivery or takeout. The GUI 550 may include a selectable GUI element which, when selected, displays reviews posted by users of the restaurant searching website, and which may further include and display comments made to such reviews posted by other users and/or by an owner/manager/employee of the selected restaurant. The GUI 550 may include one or more photos 560 of food items offered by the selected restaurant.

The GUI 550 may include an identification of the hours of the day 562 during which the selected restaurant is open for business. The GUI 550 may include a map illustrating the geographic location of the selected restaurant. The GUI 550 may include a GUI element 566 identifying whether the restaurant offers delivery, takeout and/or dine-in. The GUI 550 may include a GUI element 568 which identifies an average cost range of food items offered by the selected restaurant. The GUI 550 may include a GUI element 570 indicating a current operating status, e.g., open, closed, busy, no-waiting, etc. of the selected restaurant. It will be understood that, in addition to the menu 556, the GUI 550 may include any one or combination of the items just described, or may alternatively include more, fewer or different items, than those illustrated in FIG. 9, and that any such alternate arrangement of the GUI 550 is intended to fall within the scope of this disclosure.

Referring again to FIG. 7, the process 400 advances from step 408 to step 410 where the processor 34 is operable to determine whether the user has selected the food menu 556 in the GUI 550, or has selected a “back” GUI element. If the latter, the process 400 loops back to step 402. If the user has selected the food menu, the process 400 advances to step 412 where the processor 34 is operable to generate for display on the user's computing device a GUI of the selectable food menu, i.e., a GUI of the food menu 556 including user-selectable food items. Thereafter at step 414, the processor 34 is operable to determine whether the user has selected a food item from the menu 556 or has selected a “back” GUI element. If the latter, the process 400 loops back to step 402, and if the former the process 400 advances to step 416 where the processor is operable to generate for display on the user's computing device a GUI of information about the selected food item illustratively including one or more modification and/or ordering options. As one example, if the user selects a particular “pizza” from the menu 556, the GUI generated at step 416 may include a GUI element via which the user may select a desired number of the pizzas to be purchased by the user. Alternatively or additionally, the GUI generated at step 416 may include a GUI element (or elements) via which the user may select one or more items to add to the pizza, e.g., along with costs associated with each item. Those skilled in the art will recognize other modifications and/or ordering options that may be included in the GUI generated at step 416, and such other modifications and/or ordering options are intended to fall within the scope of this disclosure.

From step 416, the process 400 advances to step 418 where the processor 34 is operable to determine whether the user has ordered a food item by selecting one of the menu offerings displayed in the menu at step 412, or whether the user has selected a “back” GUI element. If the latter, the process 400 loops back to step 402, and if the former the process 400 advances to step 420 where the processor 34 is operable to execute an order process.

Following step 420, the process 400 returns to the process 300 at step 310 which, in turn, returns to the process 200 at step 214. Although not specifically shown in FIG. 7, the process 400 illustratively includes a manual exit mechanism, e.g., a suitable GUI element in each of the GUIs produced in the process 400, which may be selected at any time by the user, the effect of which will be to immediately return the process 400 to step 214 of the process 200 for user selection of a different DSO element, e.g., to conduct a different type of restaurant/food search or restart the restaurant/food search previously being conducted.

Referring now to FIG. 10, a flowchart is shown of an embodiment of a process 600 for selecting a food item from a list of food items, at least some of which are offered by different restaurants, which was generated at step 326 of the process 300 illustrated in FIG. 6. In some search results, each of the food items in the list of food items are offered by a different restaurant within the current GRU, and in other search results two or more of the food items in the list of food items may be offered by the same restaurant within the current GRU. As with the processes 200, 300 and 400, the process 600 is illustratively stored in the memory 38 and/or data storage 40 of the RSS server 32 in the form of instructions executable by the processor 34 to cause the processor 34 to carry out the corresponding functionality.

The process 600 illustratively begins at step 602 where the processor 34 is operable to determine whether the user has selected a food item from the list of food items generated at steps 326 of the process 300 illustrated in FIG. 6 or whether the user has instead selected one of the search filters 132. If the processor 34 determines at step 602 that the user has selected one of the search filters included in a corresponding one of the GUIs generated at step 326, the process 600 advances to step 604 where the processor 34 is operable to generate for display on the user's computing device a GUI which displays the selected search filter GUI. Thereafter at step 606, the processor 34 is operable to modify the search results based on user selection of one of the search filters displayed in the selected search filter GUI. The user-selectable search filters may be or include any one or more of the search filters described above with respect to steps 404 and 406 of the process 400, or may alternatively include more, fewer or different search filters, additional ones of which may include search filters corresponding to any one or more of the user-selectable search criteria described herein. In any case, the process 600 loops from step 606 back to step 602 after the current food item search results have been refined by one or more user-selected search filter elements of a user-selected search filter GUI. At step 602, the user may again select the same or another search filter to further refine the food item search results, or may instead select a food item from the current list of food item search results. If the processor 34 determines the latter to be the case, the process 600 advances to step 608 where the processor 34 is operable to generate for display on the user's computing device a GUI which includes information about the selected food item including, for example, one or more modification and/or ordering options, e.g., in the form of user-selectable GUI elements. The GUI generated at step 608 may include various information about the selected food, some of which may be selectable by the user and some of which may only be viewed. Examples of information about the food item that may be included in the GUI generated at step 608 may include, but are not limited to, a description of the food item, a photo of the food item. The ordering and/or modification options may be as described above with respect to step 416 of the process 400.

Following step 608, the process 600 advances to step 610 where the processor 34 is operable to determine whether the user has ordered a food item by selecting an order GUI element displayed in the GUI generated at step 608, or whether the user has selected a “back” GUI element. If the latter, the process 600 loops back to step 602, and if the former the process 600 advances to step 612 where the processor 34 is operable to execute an order process. In some embodiments, the ability to order food from “food view” search results is available only when searching in the “food order” process or “restaurant discover” process in which the “Order” mode (delivery or takeout) is enabled (in contrast to the “restaurant reservation” process in which the “Order” mode is not enabled).

Following step 612, the process 600 returns to the process 300 at step 326 which, in turn, returns to the process 200 at step 214. Although not specifically shown in FIG. 10, the process 600 illustratively includes a manual exit mechanism, e.g., a suitable GUI element in each of the GUIs produced in the process 600, which may be selected at any time by the user, the effect of which will be to immediately return the process 600 to step 214 of the process 200 for user selection of a different DSO element, e.g., to conduct a different type of restaurant/food search or restart the restaurant/food search previously being conducted.

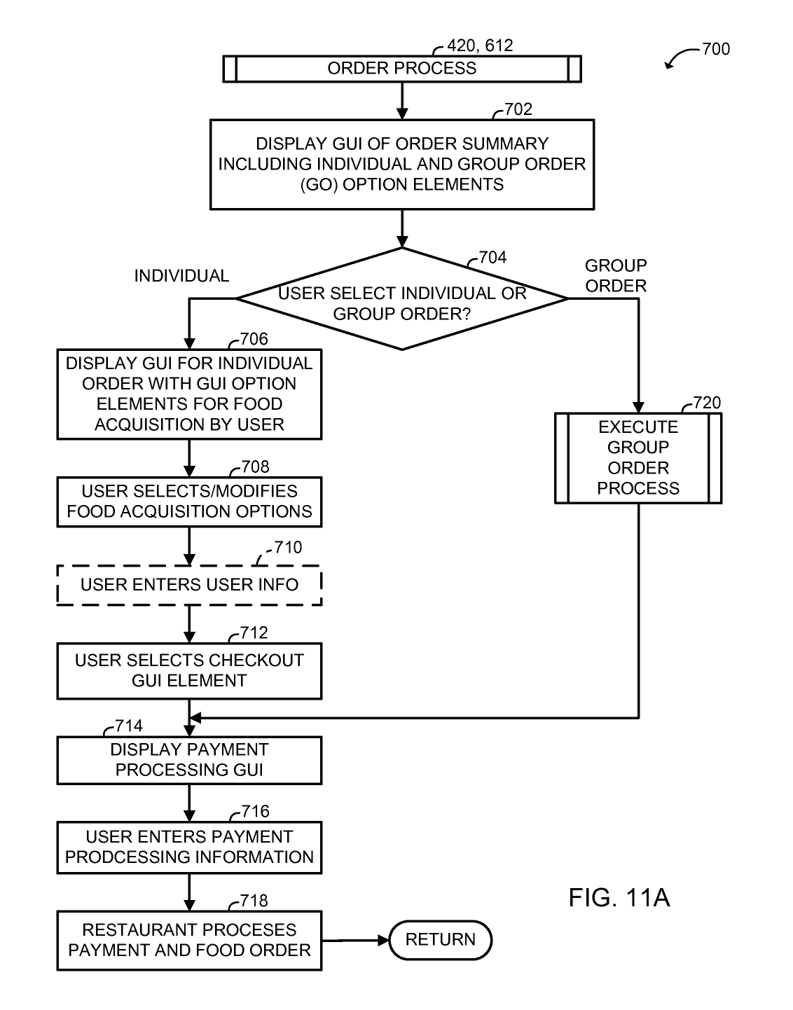

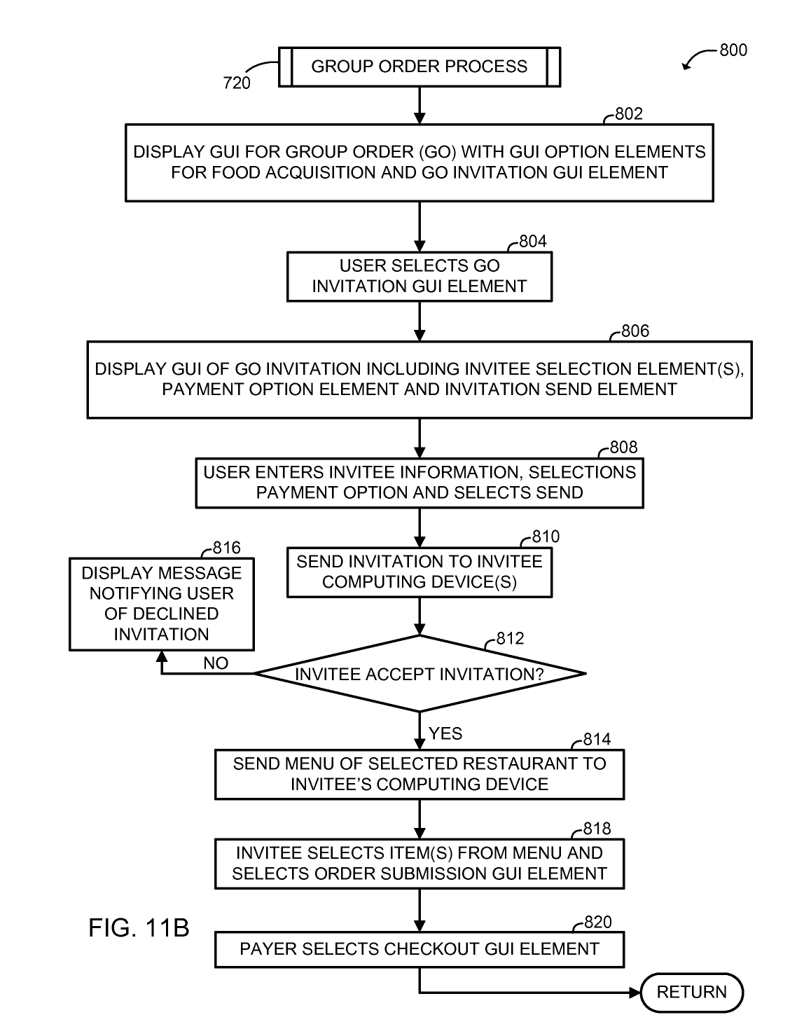

Referring now to FIG. 11A, a flowchart is shown of an embodiment of a process 700 for executing an order for a selected food item made by a user at step 420 of the process 400 illustrated in FIG. 7 or made by a user at step 612 of the process 600 illustrated in FIG. 10. As with the processes 200, 300, 400 and 600, the process 700 is illustratively stored in the memory 38 and/or data storage 40 of the RSS server 32 in the form of instructions executable by the processor 34 to cause the processor 34 to carry out the corresponding functionality.

The process 700 illustratively begins at step 702 where the processor 34 is operable to generate for display on the user's computing device a GUI which includes summary details of the order placed by the user for a food item from a selected restaurant. Illustratively, the order summary includes individual and group order (GO) option elements. From step 702, the process 700 advances to step 704 where the processor 34 is operable to determine whether the user has selected the individual order element displayed in the GUI generated at step 702 or whether the user has selected the group order element also displayed in the GUI generated at step 702. If the former, the process 700 advances to step 706 where the processor 34 is operable to generate for display on the user's computing device a GUI for an individual order, e.g., for a food order placed only by the user, which illustratively includes information and GUI option elements relating to the manner in which the user will acquire the food. For example, the GUI generated at step 706 may illustratively include “delivery” and “takeout” GUI option elements, and the user may select either to establish the manner in which the user will acquire the ordered food item(s). The GUI generated at step 706 may further include selectable GUI elements which allow the user to select a geographic location to which the user would like the ordered food item(s) delivered and/or to allow the user to select a time of day at which the user would like the ordered food item(s) to be delivered or to be available for takeout.

At step 708, the user selects and/or modifies the food acquisition option element(s), and the process 700 may further optionally include a step 710 at which the user enters user information into the GUI, e.g., information identifying the user to the restaurant from which the food item(s) were ordered, e.g., name, address, telephone number and/or email address. Thereafter at step 712 the user may select a “checkout” GUI element displayed in the GUI generated at step 706. In some embodiments, if the user has previously ordered food from a restaurant, the user's identifying information may be auto-filled or otherwise selected by the user as the processor 34 is operable to save all such user order information in the database 100.

Following user selection of the checkout GUI element, the processor 34 is operable at step 714 to generate for display on the user's computing device a GUI for the processing of an electronic form of payment by the user for the ordered food item(s). Thereafter at step 716, the user enters electronic payment processing information into the GUI generated at step 714. In some embodiments, the restaurant, e.g., the restaurant website, is operable thereafter at step 718 to process the payment and generates the food order. In other embodiments, the restaurant searching website is operable at step 718 to process the payment and to instruct the restaurant to generate the food order.

In some embodiments, restaurants and/or the restaurant searching website may offer discount deals for food purchases, and in some such embodiments the processor 34 may be operable to automatically deduct the discount amount of the deal as soon as the order satisfies the discount criteria. For example, if a discount deal offers $5.00 off every order above $20.00, the processor 34 will automatically deduct $5.00 from any order that reaches $20.00 or higher.

Following step 718, the process 700 returns to the process 400 at step 420 or to the process 600 at step 612 which, in turn, returns to the process 200 at step 214. Although not specifically shown in FIG. 11A, the process 700 illustratively includes a manual exit mechanism, e.g., a suitable GUI element in each of the GUIs produced in the process 700, which may be selected at any time by the user, the effect of which will be to immediately return the process 700 to step 214 of the process 200 for user selection of a different DSO element, e.g., to conduct a different type of restaurant/food search or restart the restaurant/food search previously being conducted.

If, at step 704, the processor 34 determines that the user has selected the group order element displayed in the GUI generated at step 702, the process 700 advances to step 720 where the processor 34 is operable to execute a group order process. Following step 720, the process 700 advances to step 714 to execute steps 714-1718 in order to process payment for the group order.

Referring now to FIG. 11B, a flowchart is shown of an embodiment of a process 800 for executing the group order process selected by a user of the restaurant searching website at step 720 of the process 700 illustrated in FIG. 11A. As with the processes 200, 300, 400, 600 and 700, the process 800 is illustratively stored in the memory 38 and/or data storage 40 of the RSS server 32 in the form of instructions executable by the processor 34 to cause the processor 34 to carry out the corresponding functionality.

In some embodiments, the food item order GUIs of one or more restaurants may include an option to create a “group order” by inviting others to select food items as part of the user's order, and in this regard the process 800 illustratively begins at step 802 where the processor 34 is operable to generate for display on the user's computing device a GUI which includes information for a group order process including, for example, GUI option elements for food acquisition and a group order invitation element. In one embodiment, the group order process requires the user initiating the group order to establish the manner in which the group of individuals will acquire the subsequently ordered food items, e.g., via delivery to a specified geographic location (and, optionally, at a specified time of day) or via takeout (and, optionally, at a specified time of day). In this embodiment, the manner specified by the user initiating the order in which the group of individuals forming the group order will acquire the subsequently ordered food items cannot be modified by any other individuals. In other embodiments, one or more of the other individuals, e.g., those individuals (or sole individual) responsible for paying for the food order, may have rights to modify the manner in which the group will acquire the ordered food items.

After the user making an initial food order has selected the manner in which the food order will be acquired, the user selects at step 804 the group order invitation GUI element displayed in the GUI generated at step 802. Thereafter at step 806, the processor 34 is operable to generate for display on the user's computing device a GUI of a group order invitation which includes one or more invitee selection elements, a payment option element and an invitation send element. The invitee selection element illustratively includes a field for entering the email addresses of persons the user wishes to invite. Alternatively or additionally, the invitee selection element may include a list of a number of different “Friends” of the user, wherein “Friends” may be individuals with which the user has established a friend connection within the restaurant searching website and/or outside of the restaurant searching website. In the latter case, the restaurant searching website illustratively includes a user interface via which the user may import “friends” from one or more social media websites.

In any case, the payment option element of the GUI illustratively includes GUI elements for user selection whether the user will pay for all food ordered by invitees or any of the invitees will pay for all food ordered by the user and all remaining invitees. Illustratively, the payment option GUI may alternatively or additionally include a GUI element for selecting each of the user and invitees to pay for their own orders, and/or for the user and/or any invitee to pay for food ordered by any one or more of the user and remaining invitees. Further illustratively, the invitation GUI may include a field for entering a message generated by the user to be sent with the invitation to all invitees. Example messages may include a maximum order price or menu item price total (e.g., in the case where the user or one of the invitees elects to pay for all food orders), or any other desired message.

At step 808, the user enters into the displayed GUI the invitee information, e.g., the user identifies the individuals whom the user wishes to include in the group order, the payment option and then selects the send element. Thereafter at step 810, the processor 34 sends the group order invitation to the various invitees (e.g., to the email address or directly to a computing device of each invitee) identified by the user in the group order invitation GUI. Illustratively, the invitation identifies the user (inviter), the restaurant selected by the user and includes “Join” and “Deny” GUI elements for selectively joining the order or declining to join the order. In one embodiment, registered users of the restaurant searching website may further be sent a notification on their mobile communication device (e.g., mobile phone) of the invitation.

The various invitees may accept, e.g., join, or decline, e.g., deny, the group order invitation by selecting a corresponding one of the “join” and “deny” GUI elements in the invitation GUI generated on their respective computing devices. At step 812, the processor 34 is operable to determine whether each invitee has accepted the group order invitation and, if not, to advance to step 814 to display a message on the user's computing device notifying the user of the declined invitation.

If, at step 812, the invitee(s) has/have accepted the group order invitation, the processor 34 is operable at step 816 send to the computing devices of each accepting invitee (e.g., via email or directly), or to otherwise make available via the restaurant searching website, the menu of the restaurant selected by the initiating user. Thereafter at step 818, the invitee(s) select one or more food items from the menu and then selects an order submission GUI element displayed in the invitee's computing device.

Selection of the “send” GUI element at step 808 illustratively causes the processor 34 to generate and display on the user's computing device a post-invitation GUI which illustratively includes an identification and status of each invitee. The status may be, for example, declined or denied, awaiting acknowledgment or joined. Illustratively, the joined status may further include a description of the food order placed by each invitee and or by the user. The GUIs displayed on computing devices of the invitees may respectively also each illustratively identify the food orders and/or other statuses of the user and each invitee. Illustratively, the status of each invitee and of the user is automatically updated periodically, and in some embodiments such updates occur with sufficient frequency so as to appear to occur in real time.

The invitees each finalize their respective food order by selecting a “Submit Order” GUI element displayed on their respective computing devices, and this action illustratively adds the cost of each such order to a cost total included in the post-invitation GUI displayed on the user's computing device if the user has offered to pay for the food orders of all invitees. The user may then complete the transaction at step 820 by selecting a “Go To Checkout” GUI element to pay for the food order using some form of electronic payment, e.g., a credit or debit card, one or more electronic (i.e., virtual) discount coupons, line of credit or the like as described with respect to FIG. 11A. In cases where one or more others are to pay the cost of all or part of the food orders, such GUI elements will be displayed on the computing devices of the respective payee(s). As described above, in the illustrated embodiment the invitees are not provided with GUI elements that allow them to modify the delivery address or time of delivery, although this disclosure contemplates embodiments in which one or more such GUIs may be provided to allow such functionality.

After the group food order is complete, the associated payment transaction) illustratively triggers production by the processor 34 of a post-order GUI in which the status of the order is illustratively displayed. Illustratively, the GUI includes a link to the user's “My Munch Ado” page where the order is automatically updated periodically and the user can therefore track the status of the order. The invitees can also track the order status on their respective “My Munch Ado” pages. In some embodiments such tracking updates occur with sufficient frequency so as to appear to occur in real time.

In the illustrated example, the post-order GUI on the user's device (center screenshot) indicates that the order has been placed and is currently awaiting delivery. Illustrated in the left and right screenshots are example post-order GUIs displayed on computing devices of invitees Nicky and Kristin respectively which also display the status of the orders. In the illustrated example, the status of the orders displayed on the invitees' devices has occurred at some point after delivery of the ordered food items, and the post-order GUIs on the invitees' devices thus indicate that the order was delivered by the selected restaurant to the user (Mike).

In some embodiments, as described above, the restaurant searching website may award points for using the restaurant searching website. In one embodiment, such points are awarded to all members of the group order. Alternatively, such points may be awarded to a subset of the group order members, e.g., to only the individual or individuals who pay for one or more food orders. In any case, the points may be awarded based on one or any combination of total amount spent for the order, choice of restaurant, choice of restaurant type, choice of menu item(s) ordered, choice of cuisine, choice of food content (or lack of content), e.g., gluten-free, low-calorie, low-fat, healthy choice, etc., and the like. The points may illustratively be redeemed with the restaurant searching website for one or more rewards, examples of which include, but are not limited to, food discounts, food or restaurant deals, e.g., 2-for-1 meals, free desert or side item, free drink, etc., exclusive food or restaurant perks, e.g., preferential table reservation dates, days of the week and/or times of day, and the like. It will be understood that while the points awarded for using the restaurant searching website have been described in the context of group ordering, such points may also be awarded for single-person ordering and other use of the restaurant searching website.

Following step 820, the process 800 returns to the process 700 at step 720. Although not specifically shown in FIG. 11B, the process 800 illustratively includes a manual exit mechanism, e.g., a suitable GUI element in each of the GUIs produced in the process 800, which may be selected at any time by the user, the effect of which will be to immediately return the process 800 to the process 700 which the user may then manually cause (e.g., as described above) the process 700 to return to step 214 of the process 200 for user selection of a different DSO element, e.g., to conduct a different type of restaurant/food search or restart the restaurant/food search previously being conducted.

Referring again to FIG. 5, step 210 of the process 200 directs the processor 34 to execute a “Food Order” process. In one embodiment, as indicated in FIG. 6, the Food Order process identified at step 210 may be implemented using the process 300 illustrated in FIG. 6; however, with the exception that step 302 illustratively includes displaying a GUI with GRU, search elements for restaurant location search and restaurant/food search, and also with GUI elements for food acquisition. Illustratively, the GUI elements for food acquisition may include “Delivery” and “Takeout,” and the user at step 304 will not only select and enter location or restaurant/food search criteria but will also specify, e.g., via selection of one of the food acquisition GUI elements, the manner in which the user intends to acquire ordered food items, i.e., via either delivery to an address specified by the user or takeout in which case the food order will be acquired at the location of the selected restaurant. Illustratively, selection of one of the food acquisition GUI elements also acts as an initial search criteria as the search engine 134 will include in the search results only those restaurants that provide for food order acquisitions in the manner selected by the user. The date and time of delivery or takeout may be specified by the user as described above with respect to the processes 400 and 600, e.g., by employing a date and/or time of day search filter such as that illustrated by example in FIG. 8F. With these modifications, the process 300, along with the associated processes 400, 600, 700 and 800 illustrated in FIGS. 7, 10, 11A and 11B respectively, may be used as described above to implement the Food Order process of step 210 of the process 200.

Referring once again to FIG. 5, step 212 of the process 200 directs the processor 34 to execute a “Restaurant Reservation” process. In one embodiment, as indicated in FIG. 6, the Restaurant Reservation process identified at step 212 may be implemented using the process 300 illustrated in FIG. 6; however, with the exceptions that the search filters displayed in the GUIs generated at steps 608, 316, 320 and 324 illustratively include a search filter for date and a search filter for time of day, and each restaurant included in the search result GUIs generated at steps 308, 316, 320 and 324 include a selectable “Reserve” GUI element. Illustratively, selection of the date search filter and/or the time of day search filter may be used to ensure that restaurants included in the search results will be able to accommodate table reservations for the specified date and/or time of day as the search engine 134 will include in the search results only those restaurants that have one or more open tables on the specified date and/or time of day. With these modifications, the process 300 may be used as described above to implement the Restaurant Reservation process of step 212 of the process 200.

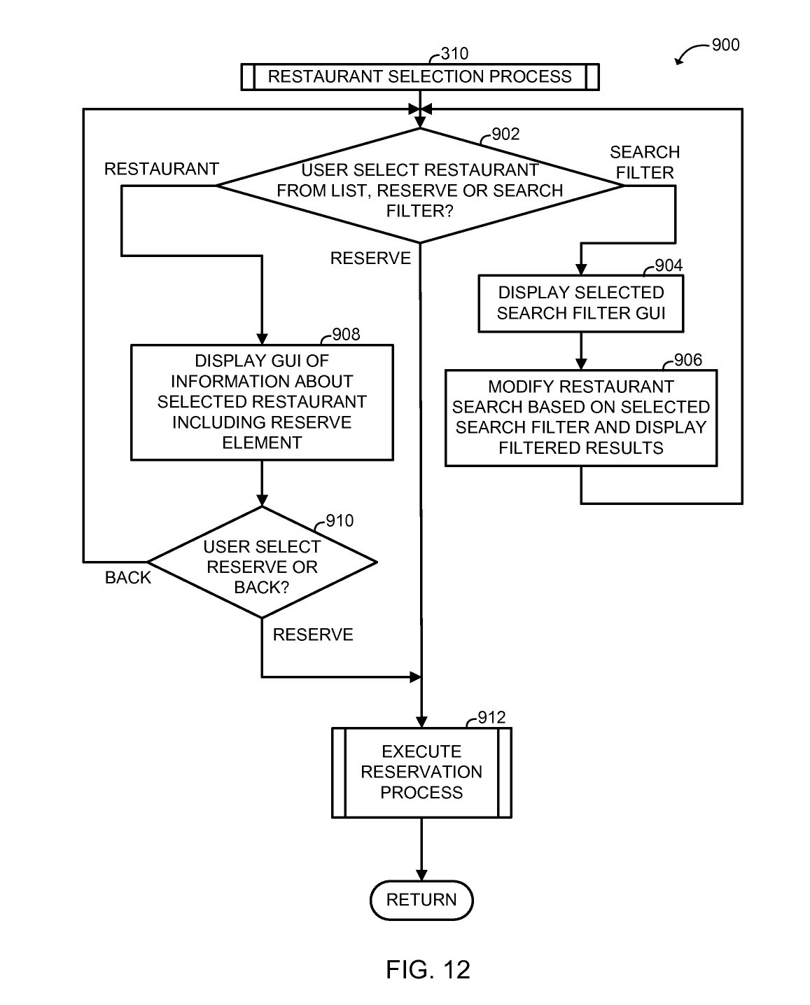

In the context of the Restaurant Reservation process, a process 900 for selecting a restaurant from a list of restaurants generated at any of steps 308, 314 and 320 of the process 300 illustrated in FIG. 6 is depicted using the simplified flowchart illustrated in FIG. 12. As with the processes 200, 300, 400, 600, 700 and 800, the process 900 is illustratively stored in the memory 38 and/or data storage 40 of the RSS server 32 in the form of instructions executable by the processor 34 to cause the processor 34 to carry out the corresponding functionality.

The process 900 illustratively begins at step 902 where the processor 34 is operable to determine whether the user has selected a restaurant from the list of restaurants generated at any of steps 308, 316 and 320 of the process 300 illustrated in FIG. 6, whether the user has instead selected one of the search filters 132 or whether the user has selected the “Reserve” GUI element of any restaurant in the search results generated at any of steps 306, 314 and 318. If the processor 34 determines at step 902 that the user has selected one of the search filters included in a corresponding one of the GUIs generated at step 308, 316 or 320, the process 900 advances to step 904 where the processor 34 is operable to generate for display on the user's computing device a GUI which displays the selected search filter GUI. Thereafter at step 906, the processor 34 is operable to modify the restaurant search results based on user selection of one of the search filters displayed in the selected search filter GUI. The various search filters available to the process 900 may include any of the search filters described hereinabove and/or illustrated in FIGS. 8A-8F, although the use of other search filters employing modified or different search criteria in the context of reserving tables at restaurants is contemplated by this disclosure. The process 900 loops from step 906 back to step 902 after the current restaurant search results have been refined by one or more user-selected search filter elements of a user-selected search filter GUI. At step 902, the user may again select the same or another search filter to further refine the restaurant search results, or may instead select a restaurant from the current list of restaurant search results or select the “Reserve” GUI element of any restaurant included in the search results displayed in the GUI generated at step 308, 316 or 320.

If the processor 34 determines at step 902 that the user has selected a restaurant from the current list of restaurant search results, the process 900 advances to step 908 where the processor 34 is operable to generate for display on the user's computing device a GUI which includes information about the selected restaurant, including a “reserve” element which the user may select to reserve a table at the restaurant. The GUI may include various information about the selected restaurant, some of which may be selectable by the user and some of which may only be viewed. The process 900 advances from step 908 to step 910 where the processor 34 is operable to determine whether the user has selected the “Reserve” element of the restaurant displayed in the GUI generated at step 908, or has selected a “back” GUI element. If the latter, the process 900 loops back to step 902. If the user has instead selected the “Reserve” element, the process 900 advances to step 912 where the processor 34 is operable to execute a Reservation process. Likewise, if the processor 34 determines at step 902 that the user has selected the “Reserve” GUI element of any restaurant included in the search results displayed in the GUI generated at step 308, 316 or 320, the process 900 advances to step 912 where the processor 34 is operable to execute the Reservation process.

Following step 912, the process 900 returns to the process 300 at step 310 which, in turn, returns to the process 200 at step 214. Although not specifically shown in FIG. 12, the process 900 illustratively includes a manual exit mechanism, e.g., a suitable GUI element in each of the GUIs produced in the process 900, which may be selected at any time by the user, the effect of which will be to immediately return the process 900 to step 214 of the process 200 for user selection of a different DSO element, e.g., to conduct a different type of restaurant/food search or restart the restaurant/food search previously being conducted.

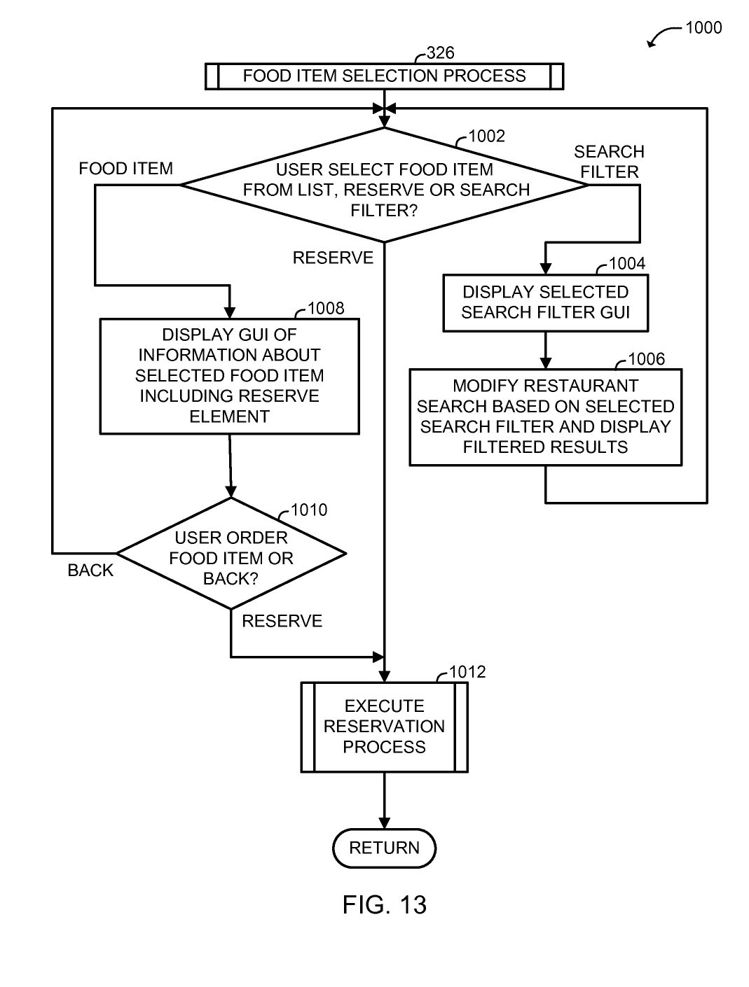

Referring now to FIG. 13, a flowchart is shown of an embodiment of a process 1000 for selecting a restaurant which offers a food item from a list of food items generated at step 326 of the process 300 illustrated in FIG. 6. In some search results, each of the food items in the list of food items are offered by a different restaurant within the current GRU, and in other search results two or more of the food items in the list of food items may be offered by the same restaurant within the current GRU. As with the processes 200, 300, 400, 600, 700, 800 and 900, the process 1000 is illustratively stored in the memory 38 and/or data storage 40 of the RSS server 32 in the form of instructions executable by the processor 34 to cause the processor 34 to carry out the corresponding functionality.

The process 1000 illustratively begins at step 1002 where the processor 34 is operable to determine whether the user has selected a food item from the list of food items generated at step 326 of the process 300 illustrated in FIG. 6, whether the user has selected the “Reserve” GUI element of a restaurant associated any food item in the search results displayed in the GUI generated at step 326, or whether still the user has instead selected one of the search filters 132. If the processor 34 determines at step 1002 that the user has selected one of the search filters included in a corresponding one of the GUIs generated at step 326, the process 1000 advances to step 1004 where the processor 34 is operable to generate for display on the user's computing device a GUI which displays the selected search filter GUI. Thereafter at step 1006, the processor 34 is operable to modify the search results based on user selection of one of the search filters displayed in the selected search filter GUI. The user-selectable search filters may be or include any one or more of the search filters described above with respect to steps 404 and 406 of the process 400, or may alternatively include more, fewer or different search filters, additional ones of which may include search filters corresponding to any one or more of the user-selectable search criteria described herein and/or illustrated by example in FIGS. 8A-8F. In any case, the process 1000 loops from step 1006 back to step 1002 after the current food item search results have been refined by one or more user-selected search filter elements of a user-selected search filter GUI. At step 1002, the user may again select the same or another search filter to further refine the food item search results, or may instead select a food item from the current list of food item search results or select the “Reserve” GUI element of a restaurant associated any food item in the search results displayed in the GUI generated at step 326.

If the processor 34 determines at step 1002 that the user has selected a food item from the current list of food item search results, the process 1000 advances to step 1008 where the processor 34 is operable to generate for display on the user's computing device a GUI which includes information about the selected food item including, for example, a “Reserve” GUI element of the selected restaurant that offers the selected food item. The GUI generated at step 1008 may include various information about the selected food item and/or restaurant, some of which may be selectable by the user and some of which may only be viewed. Examples of information about the food item that may be included in the GUI generated at step 608 may include, but are not limited to, a description of the food item, a photo of the food item.

Following step 1008, the process 1000 advances to step 1010 where the processor 34 is operable to determine whether the user has selected the “Reserve” GUI element of the selected restaurant that offers the selected food item displayed in the GUI generated at step 1008, or whether the user has selected a “back” GUI element. If the latter, the process 1000 loops back to step 1002, and if the former the process 1000 advances to step 1012 where the processor 34 is operable to execute a Reservation process. Likewise, if the processor 34 determines at step 1002 that the user has selected the “Reserve” element of a restaurant that offers one of the food items listed in the food item search results generated at step 326 of the process 300, the process 1000 advances to step 1012 where the processor 34 is operable to execute the Reservation process.

Following step 1012, the process 1000 returns to the process 300 at step 326 which, in turn, returns to the process 200 at step 214. Although not specifically shown in FIG. 13, the process 1000 illustratively includes a manual exit mechanism, e.g., a suitable GUI element in each of the GUIs produced in the process 1000, which may be selected at any time by the user, the effect of which will be to immediately return the process 1000 to step 214 of the process 200 for user selection of a different DSO element, e.g., to conduct a different type of restaurant/food search or restart the restaurant/food search previously being conducted.

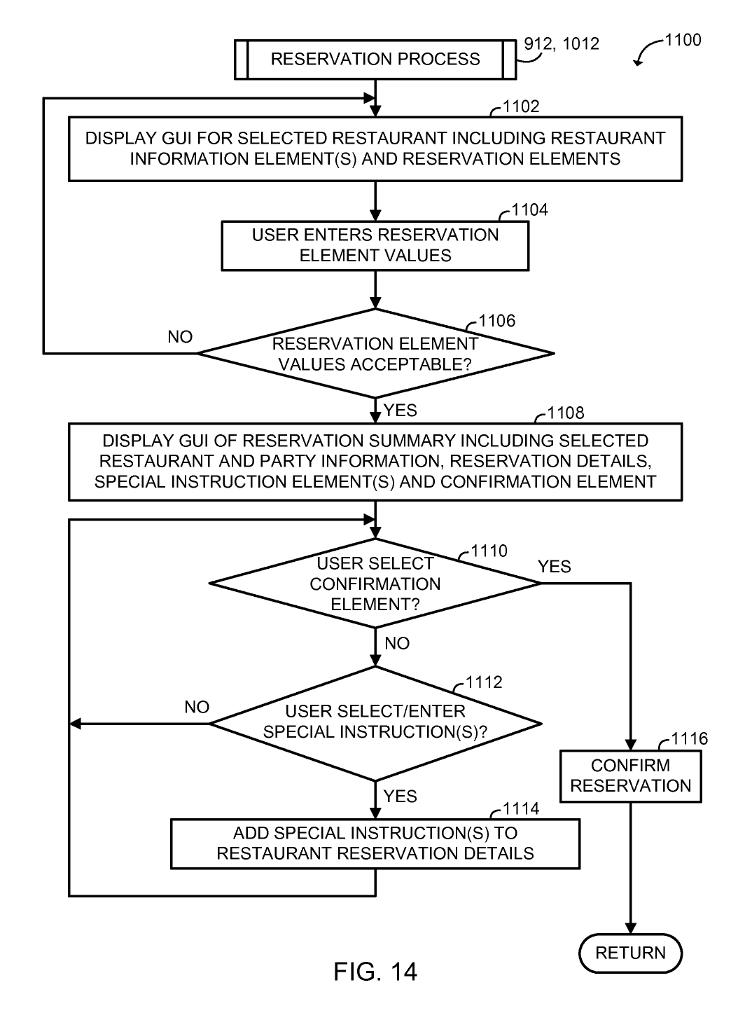

Referring now to FIG. 14, a flowchart is shown of an embodiment of a process 1100 for executing the Reservation process identified at step 912 of the process 900 illustrated in FIG. 12 and at step 1012 of the process 1000 illustrated in FIG. 13. As with the processes 200, 300, 400, 600, 700, 800, 900 and 1000, the process 1100 is illustratively stored in the memory 38 and/or data storage 40 of the RSS server 32 in the form of instructions executable by the processor 34 to cause the processor 34 to carry out the corresponding functionality.

The process 1100 illustratively begins at step 1102 where the processor 34 is operable to generate for display on the user's computing device a GUI which includes one or more restaurant information elements and a number of reservation elements. In one embodiment, the one or more restaurant information elements may include one or any combination of a restaurant description element which, if selected, causes the processor 34 to generate for display on the user's computing device a GUI or portion thereof which includes a description or overview of the restaurant, a menu element which, if selected, causes the processor 34 to generate for display on the user's computing device a menu of food items offered by the restaurant, a gallery element which, if selected, causes the processor 34 to generate for display on the user's computing device a GUI or portion thereof one or more photos of the restaurant, of food items offered by the restaurant and/or of restaurant patrons, and a review element which, if selected, causes the processor 34 to generate for display on the user's computing device a GUI or portion thereof one or more reviews posted by one or more users of the restaurant searching website. The GUI generated at step 1102 may further include additional information about the restaurant such as name, address, hours of business, a map of the location, etc.

Illustratively, the number of reservation elements included in the GUI generated at step 1102 include a party size element, a date (i.e., calendar date) element and a time of day element, all of which the user selects or enters at step 1104 in order to fully define the reservation request. The party size element may be a text field or a pull-down menu, and in any case allows the user to specify the size of the party for which the reservation is being requested. Each of the date and time of day elements may likewise be text fields or pull-down menus, an example of the latter implementation being provided by example in FIG. 8F. In any case, the user specifies via the date element a calendar date on which the reservation is being requested, and specifies via the time of day element a time of day at which the reservation is being requested.

The process 1100 advances from step 1104 to step 1106 where the processor 34 determines whether the reservation element values specified by the user at step 1104 are acceptable, i.e., whether the selected restaurant can accommodate the table reservation for the requested party size at the requested time on the requested date. If not, the process 1100 loops back to step 1102, e.g., illustratively with a message notifying the user that the requested reservation cannot be accommodated. If, at step 1106, the processor 34 determines that the reservation element values specified by the user at step 1104 are acceptable, the process 1100 advances to step 1108 where the processor 34 is operable to generate for display on the user's computing device a GUI of a summary of the reservation request including, for example, a confirmation element and one or more of selected information about the restaurant and the user making the reservation, details of the reservation and one or more special instruction elements. The information about the restaurant may include, for example, name, address, hours of business, a map of the location, etc., and the information about the user may illustratively include name, telephone number and/or email address. In embodiments in which the user is a registered user and/or is logged on to the restaurant searching website, the processor 34 may be operable to automatically fill in the user's information from the user data 112 in the database 100. Otherwise, the processor 34 may prompt the user for entry of the user's information at step 1108.

The process 1100 advances from step 1108 to step 1110 where the processor 34 is operable to determine whether the user has selected the confirmation element in the GUI generated at step 1108. If not, the process 1100 illustratively advances to step 112 in embodiments in which the GUI generated at step 1108 includes one or more special instruction elements, where the processor 34 is operable to determine whether the user has entered or selected any special instructions. If so, the processor 34 adds the user-entered special instructions to the restaurant reservation details at step 1114 and then loops back to step 1110. In embodiments in which the GUI generated at step 1108 include special instruction elements, such special instruction elements may include text fields, pull-down menus, radio buttons or the like for special request items such as a booth, table by a window, table near or away from live musicians, children's place setting or high chair, candles at the table, or the like. In any case, if/when the user selects the confirmation element at step 1110, the process 1100 advances to step 1116 where the processor 34 confirms the reservation.

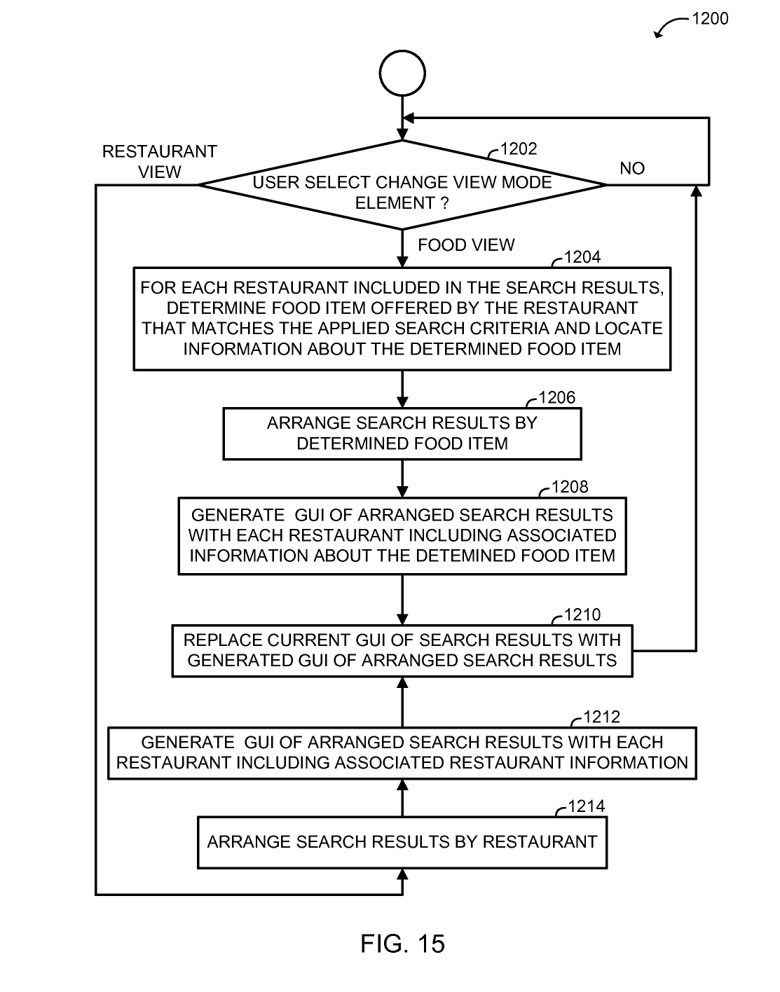

As described hereinabove with respect to the process 300 illustrated in FIG. 6, the GUIs of the restaurant search results generated at steps 308, 316 and 320 illustratively default to restaurant view mode in which the search results are arranged by restaurant information, i.e., information specific to the restaurant itself, such as restaurant name, address, photo of one or more dishes offered by the restaurant, etc., whereas the GUI of the restaurant search results generated at step 326 illustratively defaults to a “food view” mode in which the search results are arranged by the selected food item, e.g., by restaurants in the GRU that offer the selected food item, illustratively along with information about that food item, e.g., a photo of the food item, tagged as being offered by each such restaurant in the list. In some embodiments, the GUIs generated at one or more of the steps 308, 316, 320 and 326 may illustratively include one or more change view mode elements which may be selected at any time by the user to replace the GUIs displayed in restaurant view mode with GUIs displayed in food view mode, and vice versa. Referring now to FIG. 15, a simplified flowchart is shown of a process 1200 for managing such view mode changes. As with the processes 200, 300, 400, 600, 700, 800, 900, 1000 and 1100, the process 1200 is illustratively stored in the memory 38 and/or data storage 40 of the RSS server 32 in the form of instructions executable by the processor 34 to cause the processor 34 to carry out the corresponding functionality.

The process 1200 illustratively begins at step 1202 where the processor 34 is operable to determine whether the user has selected a change view mode element. If, at step 1202, the processor 34 determines that the user has selected a change view mode element to change from restaurant view mode to food view mode, the process 1200 advances to step 1204 where, for each restaurant included in the search results, the processor 34 processes information for the restaurant to determine if the restaurant offers a food item that matches the applied search criteria (i.e., initial search criteria and all applied search filters) and, if so, the processor 34 locates information about the determined food item, e.g., photo of the food item offered by the restaurant and/or text description thereof. Thus, for example, if the applied search criteria is “Thai,” and the search results in the restaurant view show restaurants that specialize in Thai food, applying step 1204 to such search results causes the processor 34 to process each restaurant in the search result list to locate information, e.g., a photo or text description, of a Thai dish offered by that restaurant.

Following step 1204, the process 1200 advances to step 1206 where the processor 34 is operable to arrange the search results by the determined food item. In some instances, step 1206 may result in the arranged search results being ordered differently than that of the original search results, and in other cases the order of the search results arranged at step 1206 may be the same as that of the original results. In any case, the process 1200 advances from step 1206 to step 1208 where the processor 34 is operable to generate a GUI of the arranged search results, i.e., of the search results as arranged at step 1206, with each restaurant including associated information, e.g., a photo or text description, about the determined food item, i.e., information descriptive of the specific food item offered by the restaurant rather than descriptive of the restaurant itself. Thus, keeping with the same example above, whereas the GUI in the restaurant view shows restaurants that specialize in Thai food, the GUI generated at step 1208 orders and shows the restaurants by the determined food item information, e.g., with each restaurant represented by a photo and/or text description of a Thai dish offered by that restaurant. In any case, the process 1200 advances from step 1208 to step 1210 where the processor 34 replaces the current GUI, i.e., the restaurant view of the search results, with the generated GUI of arranged search results, i.e., with the food view GUI of search results generated at step 1208.

If, at step 1202, the processor 34 determines that the user has selected a change view mode element to change from food view mode to restaurant view mode, the process 1200 advances to step 1212 where the processor 34 is operable to arrange the search results by restaurant, e.g., by photo/text description of the restaurant rather than a specific food item offered by the restaurant. Thereafter at step 1214, the processor 34 is operable to generate a GUI of arranged search results with each restaurant including associated restaurant information, i.e., information descriptive of the restaurant rather than of a specific food item offered by the restaurant. The process 1200 advances from step 1214 to step 1210 where the processor 34 replaces the current GUI, i.e., the food view of the search results, with the generated GUI of arranged search results, i.e., with the restaurant view GUI of search results generated at step 1214. Step 1210 illustratively loops back to step 1202.

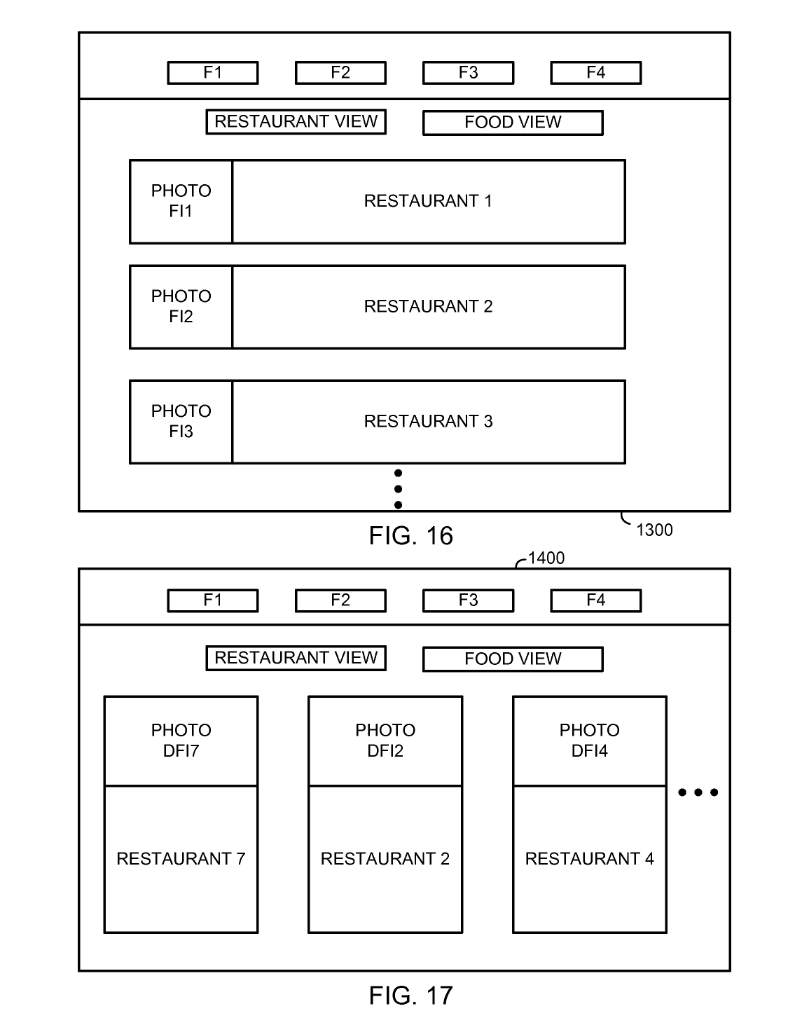

Referring now to FIGS. 16 and 17, GUIs 1300 and 1400 are shown of restaurant and food views respectively of a generic list of restaurant search results. In FIG. 16, the GUI 1300 includes a number of search filters F1-F4, Restaurant View and Food View GUI elements and a number of restaurants 1-3 shown in restaurant view with corresponding photos FI1-FI3 and accompanying text description being descriptive of the listed restaurants. In FIG. 17, the GUI 1400 also includes the search filters F1-F4, the Restaurant View and Food View GUI elements and three of the restaurants from the restaurant view GUI 1300 now shown in food view mode. As described above, in this example conversion to food view mode has rearranged the order of the displayed restaurants such that in the food view mode the restaurants are ordered 7, 2, 4 rather than 1, 2 3 as in FIG. 16. This may not occur in every view mode conversion, and in many such conversions the ordering of the restaurants will remain the same between the restaurant and food view modes. In any case, in the GUI 1400 of FIG. 17, the number of restaurants 7, 2, 4 shown in food view with corresponding photos DFI7, DFI2, DFI4 and accompanying text description are descriptive of the determined food item, i.e., of the food item of each restaurant as identified by the processor 34 based on the applied search criteria, rather than of the restaurants themselves.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, while some restaurant searching has been described herein as being based on certain user-entered search criteria with refinements being made to such searches using one or more search filters, it will be understood that any search criteria described herein may alternatively or additionally be used in the form of a search filter, and any search filter described herein may alternatively or additionally be used as search criteria for conducting initial restaurant/food item searches.

1. A computer-implemented method for at least two of discovering restaurants, booking reservations and ordering food, the method comprising:
causing, by a computing system, a first remote computing device to display a first user interface that includes at least two of a first user interface element via which a search for restaurants can be performed, a second user interface element via which a search of available restaurant reservations can be performed, and a third user interface element via which a search for restaurants from which food may be ordered remotely can be performed;
receiving, by the computing system, a first selection, specified through user interaction with the first remote computing device, of one of the at least two of the first, second and third user interface elements displayed thereon;
causing, by the computing system, the first remote computing device to display a user search interface for the selected one of the at least two of the first, second and third user interface elements;
receiving, by the computing system, search criteria, specified through user interaction with the first remote computing device using the user search interface displayed thereon, for the selected one of the at least two of the first, second and third user interface elements;
causing, by the computing system, the first remote computing device to display a list of restaurants that satisfy the specified search criteria;
receiving, by the computing system, a second selection, specified through user interaction with the first remote computing device, of one of the restaurants in the list of restaurants displayed thereon; and
as a result of receiving, by the computing system, user input specified through user interaction with the first remote computing device, booking, by the computer system, a reservation with the selected restaurant in accordance with the user input if the user input specifies a reservation request, or placing, by the computer system, an order for food with the selected restaurant in accordance with the user input if the user input specifies a food order request.

2. A system for at least two of discovering restaurants, booking reservations and ordering food, the system comprising:
a computing system having a processor and a memory having instructions stored therein which, when executed by the processor, cause the processor to cause a first remote computing device to display a first user interface that includes at least two of a first user interface element via which a search for restaurants can be performed, a second user interface element via which a search of available restaurant reservations can be performed, and a third user interface element via which a search for restaurants from which food may be ordered remotely can be performed, to receive a first selection, specified through user interaction with the first remote computing device, of one of the at least two of the first, second and third user interface elements displayed thereon, to cause the first remote computing device to display a user search interface for the selected one of the at least two of the first, second and third user interface elements, to receive search criteria, specified through user interaction with the first remote computing device using the user search interface displayed thereon, for the selected one of the at least two of the first, second and third user interface elements, to cause the first remote computing device to display a list of restaurants that satisfy the specified search criteria, to receive a second selection, specified through user interaction with the first remote computing device, of one of the restaurants in the list of restaurants displayed thereon, and as a result of receiving user input specified through user interaction with the first remote computing device, booking a reservation with the selected restaurant in accordance with the user input if the user input specifies a reservation request, or placing an order for food with the selected restaurant in accordance with the user input if the user input specifies a food order request.

3. The computer-implemented method of claim 1,
wherein the user input specifies a food order request and further includes an indication of a first item for inclusion in the order for food and an invitation for an invitee to participate in the order for food; the method further comprising:
generating, by the computing system and transmitting by the computing system to a second remote computing device that is affiliated with the invitee, a notification of the invitation;
receiving, by the computing system, an acceptance of the invitation specified through user interaction with the second remote computing device; and
as a result of receipt by the computing system of the acceptance of the invitation, causing, by the computing system, the second remote computing device to display a third user interface via which the invitee can add a second item to the order for food.

4. The system of claim 2,
wherein the user input specifies a food order request and further includes an indication of a first item for inclusion in the order for food and an invitation for an invitee to participate in the order for food, to generate and transmit to a second remote computing device that is affiliated with the invitee a notification of the invitation, to receive an acceptance of the invitation specified through user interaction with the second remote computing device, and, as a result of receipt of the acceptance of the invitation, to cause the second remote computing device to display a third user interface via which the invitee can add a second item to the order for food.

5-8. (canceled)

9. The computer-implemented method of claim 3, further comprising:
receiving, by the computing system, a selection, specified through user interaction with the second remote computing device, of the second item; and
including the second item in the order for food placed by the computer system.

10. The computer-implemented method of claim 1, wherein the search criteria specified through user interaction with the first remote computing device includes a specified geographic location,
and wherein the list of restaurants that satisfy the specified search criteria include one or more restaurants within a selectable distance from the specified geographic location.

11. The computer-implemented method of claim 1, further comprising determining, by the computing system, a geographic region in which the first remote computing device is located;
wherein the list of restaurants includes one or more restaurants located within the geographic region.

12. The computer-implemented method of claim 11, wherein the search criteria specified through user interaction with the first remote computing device includes one of a specified cuisine type, a specified restaurant name, and a specified geographic location,
and wherein the list of restaurants that satisfy the specified search criteria includes at least one restaurant within the geographic region which serves food of the specified cuisine type, which matches the specified restaurant name or which is located within a selectable distance from the specified geographic location, respectively.

13. The computer-implemented method of claim 1, further comprising causing, by the computing system, the first remote computing device to display information about the selected restaurant including a food menu of the selected restaurant.

14. The computer-implemented method of claim 13, further comprising:
receiving, by the computing system, a third selection, specified through user interaction with the first remote computing device, of one of the food items included in the food menu of the selected restaurant;
causing, by the computing system, the first remote computing device to display information about the selected one of the food items; and
receiving, by the computing system, the user input, specified through user interaction with the first remote computing device, the user input specifying the food order request in the form of an order for the selected one of the food items from the selected restaurant.

15. The computer-implemented method of claim 1, further comprising causing, by the computing system, the first remote computing device to display information about the selected restaurant and an interface including one or more reservation elements.

16. The computer-implemented method of claim 15, further comprising:
receiving, by the computing system, one or more reservation element values, specified through user interaction with the first remote computing device, corresponding to the one or more reservation elements displayed thereon;
causing, by the computing system, the first remote computing device to display reservation summary information including the one or more reservation element values; and
receiving, by the computing system, the user input, specified through user interaction with the first remote computing device, the user input specifying the reservation with the selected restaurant in the form of a confirmation of the one or more reservation element values.

17. The system of claim 2, wherein the search criteria specified through user interaction with the first remote computing device includes a specified geographic location,
and wherein the instructions stored in the memory further include instructions which, when executed by the processor, cause the processor to include in list of restaurants that satisfy the specified search criteria include one or more restaurants within a selectable distance from the specified geographic location.

18. The system of claim 2, wherein the instructions stored in the memory further include instructions which, when executed by the processor, cause the processor to:
determine a geographic region in which the first remote computing device is located; and
include in the list of restaurants one or more restaurants located within the geographic region.

19. The system of claim 18, wherein the search criteria specified through user interaction with the first remote computing device includes one of a specified cuisine type, a specified restaurant name, and a specified geographic location,
and wherein the instructions stored in the memory further include instructions which, when executed by the processor, cause the processor to include in the list of restaurants that satisfy the specified search criteria at least one restaurant within the geographic region which serves food of the specified cuisine type, which matches the specified restaurant name or which is located within a selectable distance from the specified geographic location, respectively.

20. The system of claim 2, wherein the instructions stored in the memory further include instructions which, when executed by the processor, cause the processor to cause the first remote computing device to display information about the selected restaurant including a food menu of the selected restaurant.

21. The system of claim 20, and wherein the instructions stored in the memory further include instructions which, when executed by the processor, cause the processor to receive a third selection, specified through user interaction with the first remote computing device, of one of the food items included in the food menu of the selected restaurant, to cause the first remote computing device to display information about the selected one of the food items, and to receive the user input, specified through user interaction with the first remote computing device, wherein the user input specifies the food order request in the form of an order for the selected one of the food items from the selected restaurant.

22. The system of claim 2, wherein the instructions stored in the memory further include instructions which, when executed by the processor, cause the processor to cause the first remote computing device to display information about the selected restaurant and an interface including one or more reservation elements.

23. The system of claim 22, wherein the instructions stored in the memory further include instructions which, when executed by the processor, cause the processor to receive one or more reservation element values, specified through user interaction with the first remote computing device, corresponding to the one or more reservation elements displayed thereon, to cause the first remote computing device to display reservation summary information including the one or more reservation element values, and to receive the user input, specified through user interaction with the first remote computing device, wherein the user input specifies the reservation with the selected restaurant in the form of a confirmation of the one or more reservation element values.

24. The system of claim 4, wherein the instructions stored in the memory further include instructions which, when executed by the processor, cause the processor to receive a selection, specified through user interaction with the second remote computing device, of the second item; and to include the second item in the order for food placed by the computer system.
